(19) United States
(12) Patent Application Publication
(10) Pub. No.: US 2007/0165077 A1
(43) Pub. Date: Jul. 19, 2007

(54) Head module, liquid jetting head, liquid jetting apparatus, method of manufacturing head module, and method of manufacturing liquid jetting head

(75) Inventors: Toru Tanikawa, Kanagawa (JP); Shinji Kayaba, Tokyo (JP); Naoshi Ando, Kanagawa (JP); Masayuki Takakura, Kanagawa (JP); Makoto Ando, Tokyo (JP); Shinichi Horii, Kanagawa (JP); Takaaki Murakami, Kanagawa (JP); Manabu Tomita, Kanagawa (JP)

Correspondence Address: ROBERT J. DEPKE;LEWIS T. STEADMAN, ROCKEY, DEPKE, LYONS AND KITZINGER, LLC, SUITE 5450 SEARS TOWER, CHICAGO, IL, 60606-6306, US

(73) Assignee: SONY CORPORATION

(21) Appl. No.: 11/713,767

(22) Filed: Mar. 2, 2007

Related U.S. Application Data
(62) Division of application No. 10/971,673, filed on Oct. 22, 2004.

(30) Foreign Application Priority Data
Oct. 24, 2003 (JP) JP 2003-364934
Oct. 30, 2003 (JP) JP 2003-370596
Oct. 30, 2003 (JP) JP 2003-370597
Nov. 10, 2003 (JP) JP 2003-379421
Nov. 10, 2003 (JP) JP 2003-379425

(51) Int. Cl. B41J 2/05

(52) U.S. Cl. 347/59

(57) ABSTRACT

A head module includes a head chip provided with an array of heat generating elements, a nozzle sheet provided with nozzles, a barrier layer for forming ink liquid chambers, a module frame adhered to the nozzle sheet to thereby support the nozzle sheet and provided with a head chip arranging hole for arranging the head chip therein, and a buffer tank which is so disposed as to cover the head chip arranging hole from a surface, on the opposite side of the surface of adhesion to the nozzle sheet, of the module frame and which is for forming a common liquid conduit communicated with all the ink chambers of the head chip.

### BACKGROUND OF THE INVENTION

The present invention relates to a head module used as a head for jetting a liquid in a liquid jetting apparatus such as an ink jet printer, etc., a liquid jetting head, methods of manufacturing these, and the liquid jetting apparatus.

Conventionally, the ink jet printer has been known as one example of liquid jetting apparatus, and a variety of technologies have been disclosed in relation to the printer head of the ink jet printer.

For example, Japanese Patent Laid-open Nos. 2002-127427 and 2003-25579 each disclose a technology for assembling a line head from a plurality of head chips.

In the technology disclosed in Japanese Patent Laid-open Nos. 2002-127427 and 2003-25579, a single nozzle forming member formed of nickel by electroforming is provided with a multiplicity of nozzles (ink jet ports). A plurality of head chips are adhered to the single nozzle forming member. Furthermore, a head frame provided with such holes as to surround the head chips thus adhered is adhered to a nozzle sheet, to thereby support the nozzle sheet.

Incidentally, the head chip is provided with an array of heat generating resistors, and the head chip is adhered to the nozzle sheet so that each heat generating resistor and each nozzle correspond to each other. Besides, an ink chamber is provided between each heat generating resistor and each nozzle.

Furthermore, a conduit plate led into the holes surrounding the head chips and joined to the head chips is provided on a head frame. The conduit plate has a common conduit which is communicated with all the ink chambers.

In the above configuration, an ink is supplied from an ink tank into each ink chamber through the common conduit of the conduit plate, to fill each ink chamber. Then, the ink in the ink chamber is heated by the heat generating resistor, and the ink is jetted through the nozzle by the energy at the time of the heating.

On the other hand, as disclosed in Japanese Patent Laid-open No. 2002-86695, there is known a technology in which an assembly including a plurality of head chips is used as a single head module, and such head modules can be connected to each other for extension. In addition, as disclosed in Japanese Patent Laid-open No. Hei 7-251505, there is also known a unit type technology in which an assembly including a plurality of head chips is used as a single head module, and a plurality of such head modules are combined with each other to constitute a head assembly.

Furthermore, as disclosed in Japanese Patent Laid-open No. Hei 6-79874 and the like, there is also known a technology in which a flexible tape provided with a wiring pattern for electrical connection with a head chip is provided with nozzles to constitute a nozzle sheet, and one head chip is adhered to one nozzle sheet, simply.

However, according to the technology disclosed in Japanese Patent Laid-open Nos. 2002-127427 and 2003-25579, the conduit plate is fitted into holes in which the head chips are arranged; therefore, the fitting portions of the conduit plate are complicated in structure and need a high machining accuracy, leading to a high manufacturing cost.

In addition, the conduit plate is adhered to the three kinds of members, i.e., the nozzle forming member, the head chips, and the head frame, so that the adhesion of the conduit plate must be carried out while absorbing the dimensional accuracy present in these members, which requires a high accuracy of adhesion. As a result, there is the problem of a high assembly cost.

Further, the nozzle forming member is for forming the nozzles corresponding to all the head chips and, hence, is large in size. The large size makes it necessary to adhere the head chips in the condition where flatness is secured over the whole region, leading to a high assembly cost.

According to the technology disclosed in Japanese Patent Laid-open Nos. 2002-127427 and 2003-25579, furthermore, the head assembly as a whole must be assembled before testing the printing characteristics of the head assembly.

Therefore, if any one of the head chips is failed, the head assembly as a whole would be unusable.

Besides, even a partial trouble in the head assembly needs replacement of the whole head assembly, resulting in a high repair cost.

Furthermore, in the technology disclosed in Japanese Patent Laid-open Nos. 2002-127427 and 2003-25579, the conduit plate is fitted into the holes in which the head chips are arranged, so that the amount of the ink reserved in the surroundings of the head chips is small, with the result that the head chips and the ink in the surroundings of the head chips are brought to a high temperature.

The environment of such a high temperature adversely affects the performance, life, and troubles of the head chips which have semiconductor portions, and would cause denaturing of the ink in the common conduit.

Therefore, in order to prevent the head chips and the ink from being brought to a high temperature, it has been necessary to provide a cooling system, such as forced circulation of the ink, and to operate the cooling system at the time of jetting the ink, thereby preventing the head chips from being deteriorated and preventing the ink from being denatured.

On the other hand, according to the technology disclosed in Japanese Parent Laid-open No. 2002-86695, the performance can be checked on the basis of each ink jet print head assembly 12, and, if the ink jet print head assembly 12 is defective, it suffices to replace only the defective ink jet print head assembly 12, which promises higher productivity.

In addition, according to Japanese Patent Laid-open No. Hei 7-251505, the head assembly is configured as a unit type, thereby coping with a partial trouble in the head assembly. In Japanese Patent Laid-open No. Hei 7-251505, however, the ink conduit is split on a unit basis, so that when the ink is to be forcedly circulated by the cooling system, the ink inflow ports and the ink outflow ports of the units must be connected to each other through the conduit.

Therefore, the conduit is repeatedly bent in the vertical direction and in the left-right direction, resulting in a complicated conduit. With such a conduit, the passage resistance is so high that a hindrance is generated in smooth circulation of the ink and that it is impossible to obtain a sufficient cooling performance.

Furthermore, in Japanese Patent Laid-open No. 2002-86695, there is no disclosure of how to secure positional accuracy of nozzle opening portions 472 between a plurality of print head dies 40 (equivalent to head chips) provided in a single ink jet print head module 190. If a single nozzle forming member is provided with nozzles for all head chips, as for example in Japanese Patent Laid-open Nos. 2002-127427 and 2003-25579, little relative misregistration is generated between the nozzles. On the other hand, where a plurality of print head dies 40 are arranged, as in Japanese Patent Laid-open No. 2002-86695, a relative misregistration between the print head dies 40 would lead to a misregistration between the nozzles.

In addition, according to the technology disclosed in Japanese Patent Laid-open No. 2002-86695, the surface where the nozzle opening portion 472 is formed of the print head die 40 is projected from a first surface 301 of a support 30, as disclosed in FIG. 2 of Japanese Patent Laid-open No. 2002-86695; in the case of such a structure, the ink jetting surface is not a smooth surface, which is unfavorable.

Furthermore, it is preferable that the surfaces where the nozzle opening portions 472 are flush with each other, between the plurality of print head dies 40. For example where the ink is jetted accurately perpendicularly to the ink deposition surface of a recording medium, a misregistration, if any, of the formation surface of the nozzle opening portion 472 present between the plurality of print head dies 40 does not have a considerable influence on the print quality. However, for example where the ink jetting direction is not perfectly perpendicular to the ink deposition surface of a recording medium, a misregistration, if any, of the formation surface of the nozzle opening portion 472 present between the plurality of print head dies 40 would lead to a variation in the ink deposition position.

On the other hand, as disclosed in FIG. 1 of Japanese Patent Laid-open No. Hei 6-79874, the technology disclosed in Japanese Patent Laid-open No. Hei 6-79874 does not adopt the structure in which a conduit plate, such as the one disclosed in Japanese Patent Laid-open Nos. 2002-127427 and 2003-25579, is fitted into holes in which head chips are arranged. In other words, the head chip is merely adhered to the nozzle sheet. Therefore, the above-mentioned problem due to the fitting of the conduit plate would not be generated in this case.

However, in the structure in which head chips are adhered to a nozzle sheet provided with wiring pattern portions and electric drive power is supplied from the nozzle sheet to the head chips, a long-time driving causes the nozzle sheet to be heated by the heat generating resistors, whereby the nozzle sheet is deflexed or warped, and the flatness of the nozzle sheet is spoiled, which may lead to instable jetting of the ink. Here, in the case where only one head chip is joined to one nozzle sheet, as in Japanese Patent Laid-open No. Hei 6-79874, the nozzle sheet is small in size, so that the expansion or deflection of the nozzle sheet does not matter, even if the head chip is not fixed to a rigid head frame.

However, in the case where the material constituting the nozzle sheet is a resin polymer having a high coefficient of linear expansion or in the case where a single nozzle sheet is provided with nozzles for all head chips and a plurality of head chips are joined to the nozzle sheet, as in Japanese Patent Laid-open Nos. 2002-127427 and 2003-25579, expansion or deflection of the nozzle sheet degrades the plain surface property of the head chips, thereby adversely affecting the jetting of the ink. Particularly, the formation of a flat nozzle surface by adjusting the flatness degrees of a plurality of head chips is an important problem in adjusting the ink jetting direction, as above-mentioned.

Particularly, in Japanese Patent Application Nos. 2003-037343, 2002-360408, 2003-55236 and the like which are undisclosed conventional technologies by the present applicant, the present applicant has already proposed a technology in which the jetting direction of liquid droplets jetted from a nozzle is made variable, whereby dispersion of the droplet deposition position is made inconspicuous and the print quality can be enhanced.

Where the technology in which the jetting direction of the liquid droplets jetted from the nozzle is thus positively varied is adopted, a high accuracy is demanded as to the nozzle surface, i.e., the surface where the nozzle opening portions 472 are formed in Japanese Patent Laid-open Nos. 2002-86695. However, in Japanese Patent Laid-open Nos. 2002-86695, Hei 7-251505, and Hei 6-79874, there is no disclosure of how to secure the positional accuracy of the formation surface of the nozzle opening portion 472 between a plurality of print head dies 40.

Besides, in a printer head, the heat of the heat generating resistors at the time of printing is transferred to the members located in the surroundings of the head chips, resulting in thermal expansions due to temperature rise. Therefore, deformation such as warping due to thermal stress may be generated between the members, by the influence of differences in linear expansion coefficient. Particularly, when the members constituting the conduit are deformed under thermal stress or when the generation of thermal stress is repeated, the joint surfaces of the members constituting the conduit would be separated, possibly leading to leakage of the ink.

Furthermore, the ink jet print head assembly 12 in Japanese Patent Laid-open No. 2002-86695 is so structured as to be fitted into a first carriage rail 82 and a second carriage rail 84, but there is no description regarding the countermeasure against thermal expansion problems in the case of this structure.

Namely, in a structure in which different members are fitted to each other, there would be the problems of the generation of thermal stress and warping in the members due to thermal expansion, misregistrations between the members, etc.; particularly, a printer head is brought to a high temperature in use thereof, so that care must be given to these problems.

### SUMMARY OF THE INVENTION

It is an object of the present invention to provide a head in which the positional accuracy of nozzle formation surfaces between head chips is high and which can be used also for a line head, without raising the manufacturing cost. It is another object of the present invention to provide a head in which liquid leakage arising from thermal stress is prevented, and the generation of thermal stress, warping or misregistration can be prevented from arising from temperature variations, and which is suitable for use in a line head.

It is a further object of the present invention to provide a head in which a cooling effect for head chips and inks can be obtained without providing a special cooling system, and the positional accuracy of nozzle formation surfaces between the head chips is high, and which can be used also for a line head.

In order to attain the above objects, according to one aspect of the present invention, there is provided a head module including: a head chip including a plurality of energy generating elements arrayed at a fixed interval in one direction; a nozzle sheet provided with nozzles for jetting liquid droplets; a liquid chamber forming member laminated between the surface where the energy generating elements are formed of the head chip and the nozzle sheet so as to form a liquid chamber between each of the energy generating elements and each of the nozzles; and a module frame adhered onto one side of the nozzle sheet to thereby support the nozzle sheet and provided with a head chip arranging hole for arranging the head chip therein, a liquid in the liquid chambers being jetted through the nozzles by the energy generating elements, wherein a nozzle array is formed in the region of the head chip arranging hole of the nozzle sheet so that each of the nozzles is located at a position opposed to each of the energy generating elements of the head chip when the head chip is arranged in the head chip arranging hole, and the head module includes a buffer tank which is so disposed as to cover the head chip arranging hole from a surface, on the opposite side of the surface of adhesion to the nozzle sheet, of the module frame having the head chip arranged in the head chip arranging hole and which is for forming a common liquid conduit communicated with all the liquid chambers of the head chip.

In accordance with another aspect of the present invention, there is provided a liquid jetting head including: a plurality of the above-mentioned head modules according to the present invention; and a head frame provided with head module arranging holes for arranging therein the plurality of head modules disposed in series, the head frame adhered to each of the head modules arranged in the head module arranging holes, wherein the module frames include engaging portions for engaging with each other when the module frames are arranged in series in the arrangement direction of the nozzle arrays, and the plurality of head modules are arranged in the head module arranging holes of the head frame in the condition where the plurality of head modules are arranged in series with each other with the engaging portions thereof engaging with each other.

In accordance with a further aspect of the present invention, there is provided a liquid jetting apparatus which includes the liquid jetting head according to the present invention.

In the present invention as above, the head module includes the nozzle sheet and the module frame adhered to each other. In addition, the module frame is provided with the head chip arranging hole, and the nozzle sheet located in the head chip arranging hole is provided with the nozzle array. When the head chip is arranged in the head chip arranging hole by adhesion or the like, the energy generating elements of the head chip and the nozzles are opposed to each other.

Under this condition, the buffer tank is arranged on the head frame by adhesion or the like so as to cover the head chip arranging holes. The buffer tank is provided therein with the common liquid conduit, which is communicated with the liquid chambers of each head chip.

Further, in the liquid jetting head according to the present invention or in the liquid jetting apparatus according to the present invention, the above-mentioned head modules according to the present invention are connected in series, to constitute the liquid jetting head.

Incidentally, examples of the heat generating element in the present invention include heat generating resistors such as heaters, etc., piezoelectric elements such as piezo elements, etc., and MEMS; in the following embodiments, heat generating resistors 22 are adopted. Besides, the liquid chamber forming member in the present invention corresponds to a barrier layer 12 in the embodiments. Furthermore, in the embodiments; a module frame 11 is provided with four head chip arranging holes 11b, and one head module 10 is provided with four head chips 20. Four such head modules 10 are connected in series to obtain the length of A4 form, and such assemblies are arranged in four rows, to form a liquid jetting head 1 as a color line head for four colors of Y (yellow), M (magenta), C (cyan), and K (black).

In accordance with yet another aspect of the present invention, there is provided a head module including: a head chip including a plurality of energy generating elements arrayed at a fixed interval in one direction; a nozzle sheet provided with a nozzle array including a plurality of nozzles for jetting liquid droplets; a liquid chamber forming member laminated between the surface where the energy generating elements are formed of the head chip and the nozzle sheet so as to form a liquid chamber between each of the energy generating elements and each of the nozzle; a module frame adhered onto one side of the nozzle sheet to thereby support the nozzle sheet and provided with a head chip arranging hole for arranging the head chip therein such that the nozzle array is arranged in the region of the head chip arranging hole so that each of the nozzles is disposed at a position opposed to each of the energy generating elements of the head chip when the head chip is arranged in the head chip arranging hole; and a buffer tank which is joined to a surface, on the opposite side of the surface of adhesion to the nozzle sheet, of the module frame having the head chip arranged in the head chip arranging hole to thereby cover the head chip arranging hole and which is for forming a common conduit communicated with all the liquid chambers of the head chip, a liquid in the liquid chambers being jetted through the nozzles by the energy generating elements, wherein the module frame and the buffer tank have nearly equal coefficients of linear expansion.

In the present invention as above, the module frame and the buffer tank have nearly equal coefficients of linear expansion, so that both members show substantially the same elongation-contraction characteristics upon variations in temperature.

In accordance with a still further aspect of the present invention, there is provided a head module including: a head chip including a plurality of energy generating elements arrayed at a fixed interval in one direction; a nozzle sheet provided with nozzles for jetting liquid droplets; a liquid chamber forming member laminated between the surface where the energy generating elements are formed of the head chip and the nozzle sheet so as to form a liquid chamber between each of the energy generating elements and each of the nozzles; a module frame adhered onto one side of the nozzle sheet to thereby support the nozzle sheet and provided with a head chip arranging hole for arranging the head chip therein; and a buffer tank laminated between on a surface, opposite to the surface of adhesion to the nozzle sheet, of the module frame, for forming a common liquid conduit communicated with all the liquid chambers of the head chip, a liquid in the liquid chambers being jetted through the nozzles by the energy generating elements, wherein the inside surface of the buffer tank is so shaped as not to be fitted into the head chip arranging hole in which the head chip is arranged, and the outside surface of the buffer tank is so shaped as to extend along the outside shape of the module frame.

In the present invention as above, the inside surface of the buffer tank is so shaped as not to be fitted into the head chip arranging hole in which the head chip is arranged, and the outside surface of the buffer tank is so shaped as to extend along the outside shape of the module frame.

In accordance with still another aspect of the present invention, there is provided a head module including: a head chip including a plurality of energy generating elements arrayed at a fixed interval in one direction; a nozzle sheet provided with nozzles for jetting liquid droplets; a liquid chamber forming member laminated between the surface where the energy generating elements are formed of the head chip and the nozzle sheet so as to form a liquid chamber between each of the energy generating elements and each of the nozzles; and a module frame adhered onto one side of the nozzle sheet to thereby support the nozzle sheet and provided with a head chip arranging hole for arranging the head chip therein, a liquid in the liquid chambers being jetted through the nozzles by the energy generating elements, wherein a nozzle array is provided in the region of the head chip arranging hole of the nozzle sheet so that each of the nozzles is disposed at a position opposed to each of the energy generating elements of the head chip when the head chip is arranged in the head chip arranging hole, and a support member for fixing the head chip is provided on a surface on the opposite side of the surface where each of the energy generating elements is formed of the head chip arranged in the head chip arranging hole.

In accordance with a yet further aspect of the present invention, there is provided a liquid jetting head including: a plurality of head modules each of which includes a head chip including a plurality of energy generating elements arrayed at a fixed interval in one direction, a nozzle sheet provided with a nozzle array including a plurality of nozzles arrayed for jetting liquid droplets, a liquid chamber forming member laminated between the surface where the energy generating elements are formed of the head chip and the nozzle sheet so as to form a liquid chamber between each of the energy generating elements and each of the nozzles, and a module frame adhered onto one side of the nozzle sheet to thereby support the nozzle sheet and provided with a head chip arranging hole for arranging the head chip therein such that the nozzle array is arranged in the region of the head chip arranging hole so that each of the nozzles is disposed at a position opposed to each of the energy generating elements of the head chip when said the chip is arranged in the head chip arranging hole; and a head frame which is provided with head module arranging holes for arranging the head modules therein and in which an assembly of the plurality of head modules arranged in series so that the liquid droplet jetting surfaces of said nozzle sheets in the plurality of head modules are located in the same plain surface is arranged in the head module arranging holes, a liquid in the liquid chambers being jetted through the nozzles by the energy generating elements, wherein the head frame is connected to the module frame of each of the head modules, and the head frame and the module frames have nearly equal coefficient of linear expansion.

In the present invention as above, the assembly in which the plurality of head modules are arranged in series so that the droplet jetting surfaces (the surfaces on the opposite side of the surface of adhesion to the module frame) of the nozzle sheets in the plurality of head modules are located in the same plain surface is arranged in the head module arranging holes of the head frame. The module frame of each of the head modules is connected to the head frame. In this case, the head frame and the module frames have nearly equal coefficients of linear expansion, so that both members will show substantially the same elongation-contraction characteristics upon variations in temperature.

### BRIEF DESCRIPTION OF THE DRAWINGS

The above and other objects, features and advantages of the present invention become apparent from the following description and appended claims, taken in conjunction with the accompanying drawings, in which:

FIG. 1 shows a plan view and a side view (sectional view) along arrow X, showing one embodiment of a liquid jetting head according to the present invention;

FIG. 2 shows a sectional view and a bottom plan view, showing the configuration of a head chip mounted in the liquid jetting head and the vicinity thereof;

FIG. 3 shows a plan view and a front view showing one head module;

FIG. 4 is a plan view showing a nozzle sheet and a module frame in an exploded state;

FIG. 5 shows a plan view and a front view showing the condition where the module frame is disposed on the nozzle sheet;

FIG. 6 is a plan view showing the condition where the nozzle sheet in a head chip arranging hole is provided with a nozzle array;

FIG. 7 shows the condition where a head chip with a barrier layer laminated thereon is arranged and fixed in each head chip arranging hole;

FIG. 8 is a plan view showing the arrangement of connection pads on the head chip side;

FIG. 9 is a side sectional view for illustrating the method of connecting the connection pad of the head chip and an electrode of a wiring pattern portion of the nozzle sheet;

FIG. 10 is a side sectional view showing another embodiment of ultrasonic bonding;

FIG. 11 shows a plan view and a side view showing the condition where a buffer tank is mounted to the head module;

FIG. 12 is a side sectional view showing the condition where the buffer tank is mounted;

FIG. 13 shows a plan view and a front view showing the condition where the head modules are arranged;

FIG. 14 shows a plan view and a front view showing the step of mounting a head frame;

FIG. 15 is a plan view showing the manner in which the head frame and the head modules in an integral state are separated from a base jig;

FIG. 16 shows a plan view and a side view along arrow X, showing the step of soldering a printed wiring board and the wiring pattern portions of the nozzle sheets;

FIG. 17 shows a plan view and a side view along arrow X, showing the step of coating the soldered wiring pattern portions of the nozzle sheets with a resin;

FIG. 18 is a plan view showing the head chips and the module frame in one head module;

FIG. 19 is a plan view showing two head modules adjacent to each other;

FIG. 20 illustrates the procedure of adhering the head module into a head module arranging hole of the head frame;

FIG. 21 is a perspective view showing another embodiment of the head module;

FIG. 22 shows a bottom view of the buffer tank, and an enlarged sectional view alone line B-B;

FIG. 23 illustrates the procedure of mounting the buffer tank;

FIGS. 24A and 24B show partial sectional views, along line A-A and line B-B of FIG. 16, respectively, showing the condition where the buffer tank has been mounted;

FIG. 25 shows a plan view and a front view showing the condition where the head modules are arranged; and

FIG. 26 is a side sectional view showing the condition where a conduit plate is mounted.

### DETAILED DESCRIPTION OF THE PREFERRED EMBODIMENTS

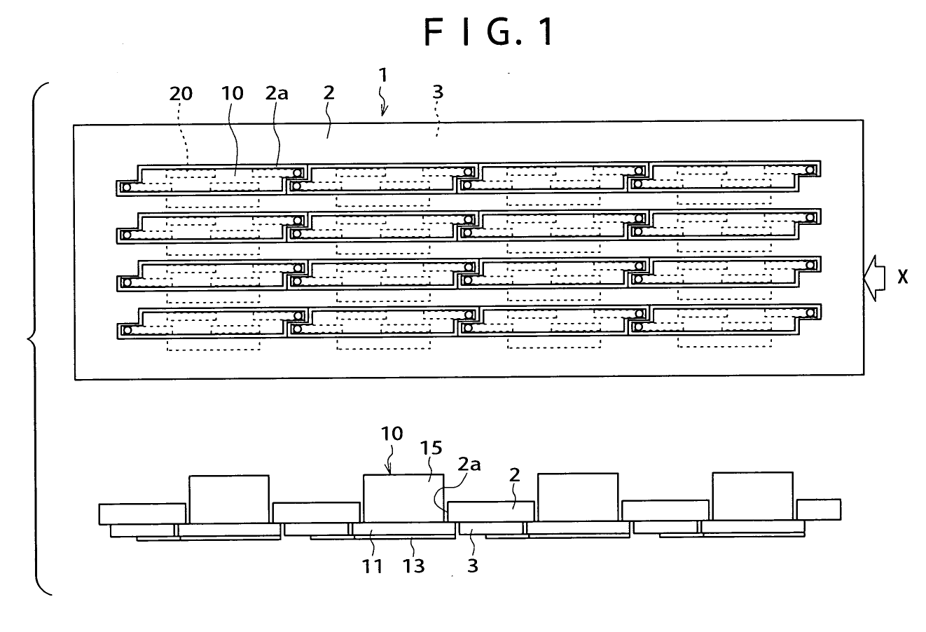

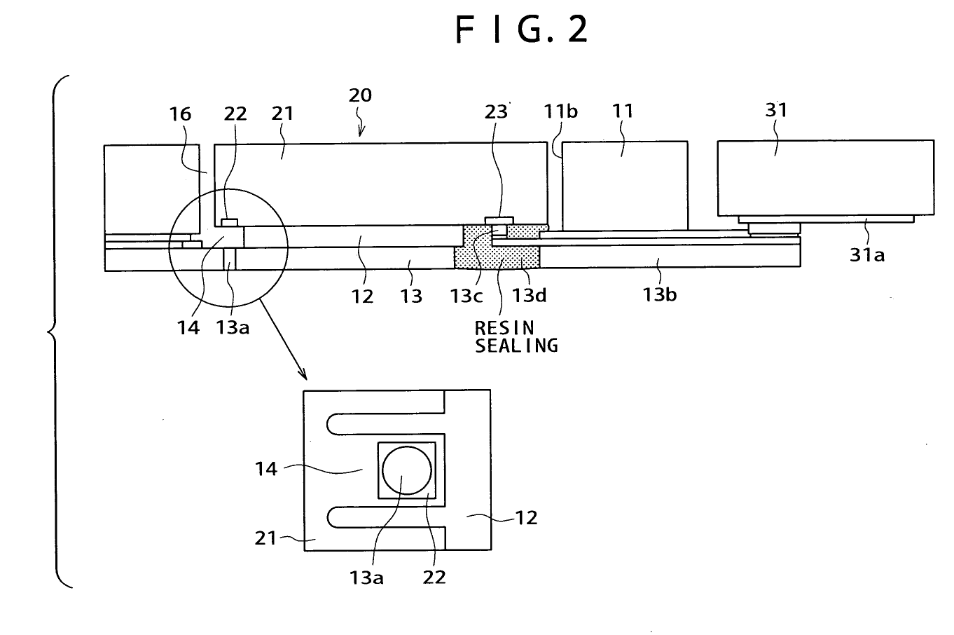

Now, one embodiment of the present invention will be described referring to the drawings. FIG. 1 shows a plan view showing a liquid jetting head 1 as one embodiment of the present invention, and a side view (sectional view) along arrow X. FIG. 2 shows a side sectional view and a bottom plan view, showing the configuration of a head chip 20 mounted in the liquid jetting head 1 and the vicinity thereof.

The liquid jetting head 1 is used as a head to be mounted in a liquid jetting apparatus (in this embodiment, a color line ink jet printer). As shown in FIG. 1, the liquid jetting head 1 is composed of a head frame 2, a printed wiring board 3, and a plurality of head modules 10. The four head modules 10 are connected in series in the longitudinal direction, in the plan view of FIG. 1, and four such assemblies (each of which include the four head modules 10 connected in series) are arranged in four rows. The four head modules 10 connected in series are used for printing in one color, and, in this embodiment, a liquid jetting head 1 (line head) for printing in four colors (Y, M, C, and K) is constructed.

In each head module 10, four head chips 20 are provided. FIG. 2 shows one head chip 20.

The head chip 20 includes a semiconductor substrate 21 formed of silicon or the like, and a heat generating resistor 22 (equivalent to an energy generating element in the present invention) deposited on one side of the semiconductor substrate 21. A connection pad 23 made of aluminum is provided at an edge portion on the opposite side of the edge portion where the heat generating element 22 is formed, on the same side as the side where the heat generating resistor 22 is formed, of the semiconductor substrate 22. The heat generating resistor 22 and the connection pad 23 are connected through a conductor portion (not shown) formed on the semiconductor substrate 21.

The surface where the heat generating resistor 22 is formed of the head chip 20 is laminated on a nozzle sheet 13, with a barrier layer 12 (equivalent to a liquid chamber forming member in the present invention) therebetween. The barrier layer 12 is for forming side walls of an ink liquid chamber 14, and is composed, for example, of a photosensitive cyclized rubber resist or an exposure-curing type dry film resist. The barrier layer 12 is formed, for example, by a method in which the resist is laminated on the whole surface, on the side where the heat generating resistor 22 is formed, of the semiconductor substrate 21, and then unnecessary portions of the resist is removed by photolithographic process.

In FIG. 2, the plan view shows one heat generating resistor 22, and the barrier layer 12 provided in the surroundings of the heat generating resistor 12. The barrier layer 12 is formed in a roughly U shape in plan view, so as to surround the vicinity of three sides of the heat generating resistor 22.

Further, the nozzle sheet 13 is provided with a plurality of nozzles 13a, and is formed of nickel by electroforming technique, for example. The nozzle sheet 13 and the barrier layer 12 are adhered to each other so that the position of the nozzle 13a and the position of the heat generating resistor 22 coincide with each other, i.e., so that the nozzle 13a is opposed to the heat generating resistor 22, specifically, so that the center axis of the nozzle 13a and the center of the heat generating resistor 22 coincide with each other as viewed on a plain surface basis (see the plan view in FIG. 2).

The ink liquid chamber 14 is composed of the semiconductor substrate 21, the barrier layer 12 and the nozzle sheet 13 so as to surround the heat generating resistor 22, is filled with an ink to be jetted, and serves as an ink pressurizing chamber at the time of jetting the ink. The surface, where the heat generating resistor 22 is formed, of the semiconductor substrate 21 constitutes the bottom wall of the ink liquid chamber 14; the portions, surrounding the heat generating resistor 22 in the roughly U shape, of the barrier layer 12 constitute the side walls of the ink liquid chamber 14; and the nozzle sheet 13 constitutes the ceiling wall of the ink liquid chamber 14. As shown in the plan view in FIG. 2, the ink liquid chamber 14 is communicated with a conduit 16 composed of the gap between the head module 11 and the semiconductor substrate 21.

The one head chip 20 as above is generally provided with one hundred or hundreds of the heat generating resistors 22, and the individual ones of the heat generating resistors 22 can be uniquely selected by a command from a control unit (not shown) of the printer, whereby the ink in the ink liquid chamber 14 corresponding to the selected heat generating resistor 22 can be jetted through the nozzle 13a opposed to this ink liquid chamber 14.

Specifically, under the condition where the ink liquid chamber 14 is filled with the ink, a pulse current is passed through the heat generating resistor 22 for a short time, for example, for 1 to 3 μsec, whereby the heat generating resistor 22 is heated rapidly. As a result, an ink bubble as a gaseous phase is generated in the ink portion in contact with the heat generating resistor 22, and expansion of the ink bubble pushes away a certain volume of the ink (the ink boils), whereby the ink, in a volume equal to the volume of the ink pushed away, at the portion in contact with the nozzle 13a is jetted from the nozzle 13a as an ink droplet. The droplet is deposited on a printing paper, to thereby form a dot (pixel).

Next, the detailed structure and manufacturing process of the head module 10 will be described below.

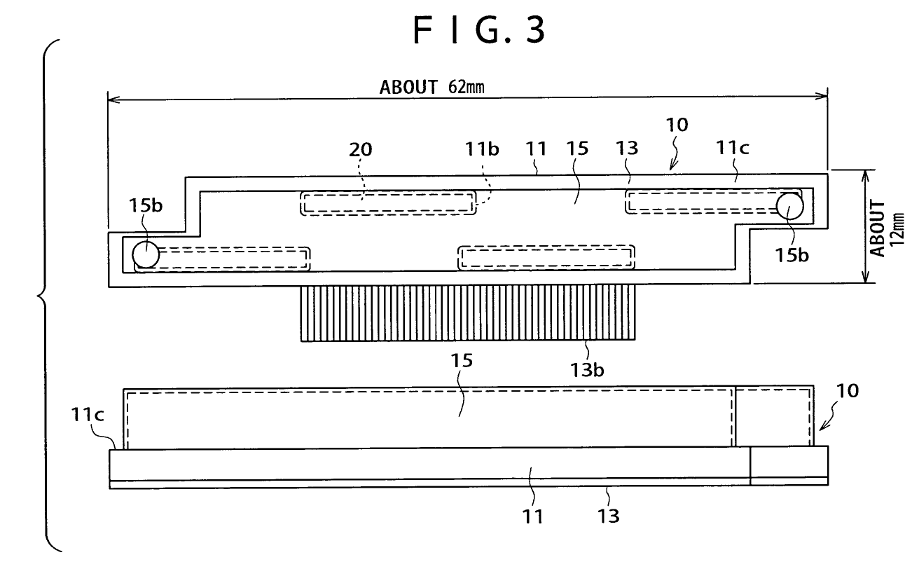

FIG. 3 shows a plan view and a front view of one head module 10. The head module 10 in this embodiment is composed of four head chips 20 arranged therein, a module frame 11, a nozzle sheet 13, and a buffer tank 15.

As shown in FIG. 3, the outside surface of the buffer tank 15 is smaller than and roughly similar to the outside shape of the module frame 11, and in the state of extending along the outside shape of the module frame 11. A portion, entirely projecting from the outside surface of the buffer tank 15, of the module frame 11 constitutes a flange portion 11c. In addition, the buffer tank 15 is merely laminated on the module frame 11, and the inside surface of the buffer tank 15 is not fitted in a head chip arranging hole 11b.

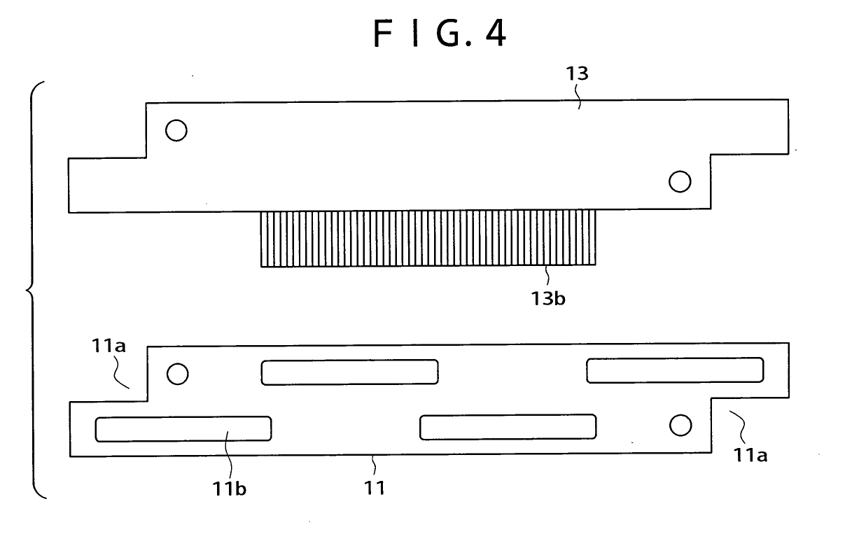

FIG. 4 is a plan view showing the nozzle sheet 13 and the module frame 11 in an exploded state.

The module frame 11 is formed in a roughly rectangular shape as viewed on a plain surface basis, and is provided on the left and right end sides thereof with engaging portions 11a cut out in a roughly L shape. As is clear from FIG. 4, the nozzle sheet 13 and the module frame 11 are so shaped that, when they are laid on each other, they substantially overlap each other, exclusive of a wiring pattern portion 13b of the nozzle sheet 13.

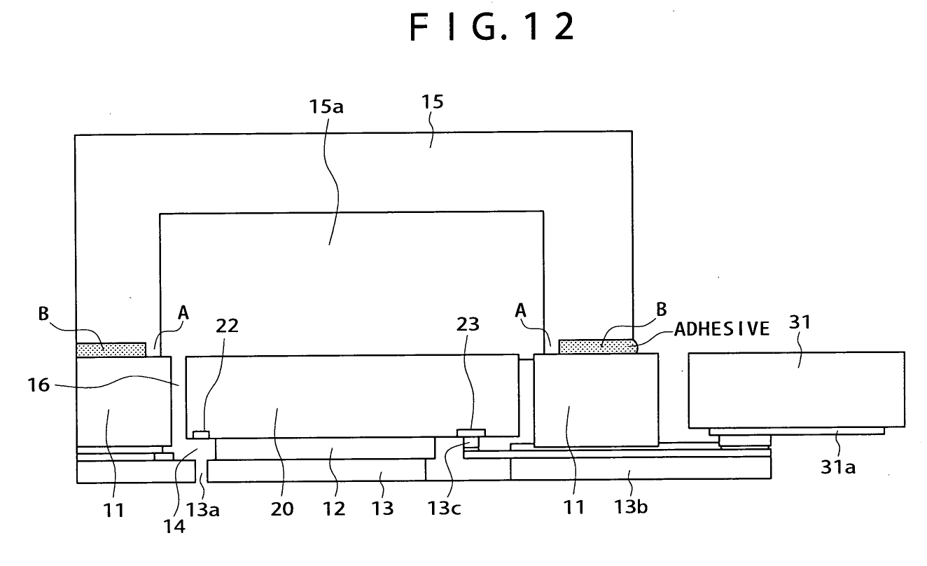

The wiring pattern portion 13b constitutes the portion, not overlapping the module frame 11, of the nozzle sheet 13, and is formed in the so-called sandwich structure in which a copper film is sandwiched by polyimide or the like. As shown in FIG. 12 later, the wiring pattern portion 13b is wired to the inside regions of the head chip arranging holes 11b so as to secure electrical connection with the head chips when the head chips 20 are arranged in the head chip arranging holes 11b.

The module frame 11 is formed of alumina ceramic, invar steel, stainless steel (e.g., SUS430 or SUS304) or the like, in a thickness of about 0.5 mm. In this embodiment, the module frame 11 is provided with roughly rectangular head chip arranging holes 11b at four locations. The head chip arranging hole 11b has a hole shape slightly greater than the outside shape of the head chip 20 so that the head chip 20 can be completely disposed in the inside of the head chip arranging hole 11b.

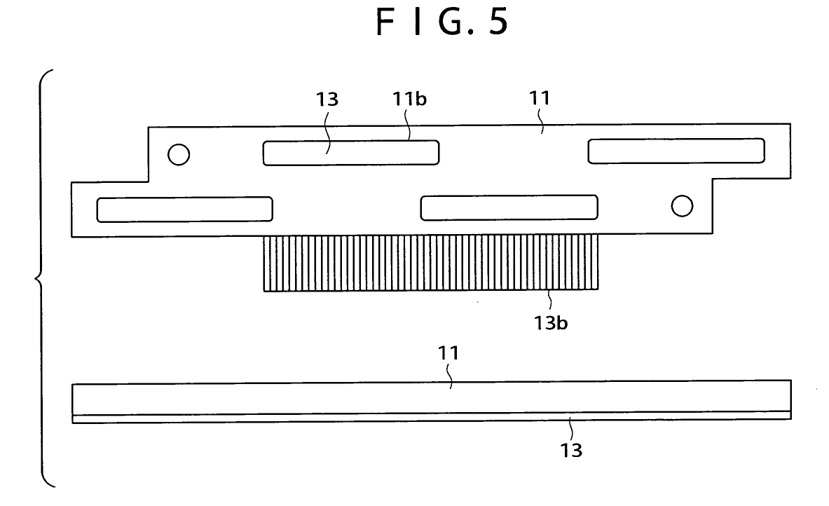

FIG. 5 shows a plan view and a front view showing the condition where the module frame 11 is arranged on the nozzle sheet 13. In this embodiment, both members are bonded to each other by thermocompression bonding by use of a hot press, whereby the module frame 11 overlaps with the region of the nozzle sheet 13 exclusive of the wiring pattern portion 13b. In other words, only the region where the wiring pattern portion 13b is formed of the nozzle sheet 13 is out of overlapping with the region of the module frame 11. In addition, in the regions of the head chip arranging holes 11b, the nozzle sheet 13 located on the lower side of the module frame 11 is seen.

Incidentally, the bonding of the module frame 11 and the nozzle sheet 13 is conducted at the highest temperature (e.g., 150° C.) in the manufacturing process of the head modules 10 and the liquid jetting head 1. The nozzle sheet 13 has a coefficient of linear expansion greater than that of the module frame 11 (the nozzle sheet 13 is more easily extended and contracted upon variations in temperature); therefore, when both of them are bonded at the highest temperature in the manufacturing process, the nozzle sheet 13 is in the state of being stretched by the module frame 11 at temperatures lower than the bonding temperature, such as at normal temperature. In other words, the elongation and contraction of the nozzle sheet 13 upon variations in temperature is governed by the module frame 11 after the bonding of the nozzle sheet 13 and the module frame 11.

Therefore, in order to secure the rigidity of the module frame 11 as much as possible, it is preferable that the opening areas of the head chip arranging holes 11b of the module frame 11 are set to the minimum necessary values. Specifically, the opening areas are minimized under such conditions that conduits 16 between a common liquid conduit 15a in the buffer tank 15 described later and the ink liquid chambers 14 are formed after the arrangement of the head chips 20 in the head chip arranging holes 11b and that the misregistration upon arrangement of the head chips 20 in accordance with the nozzles 13a formed in the nozzle sheet 13 can be absorbed.

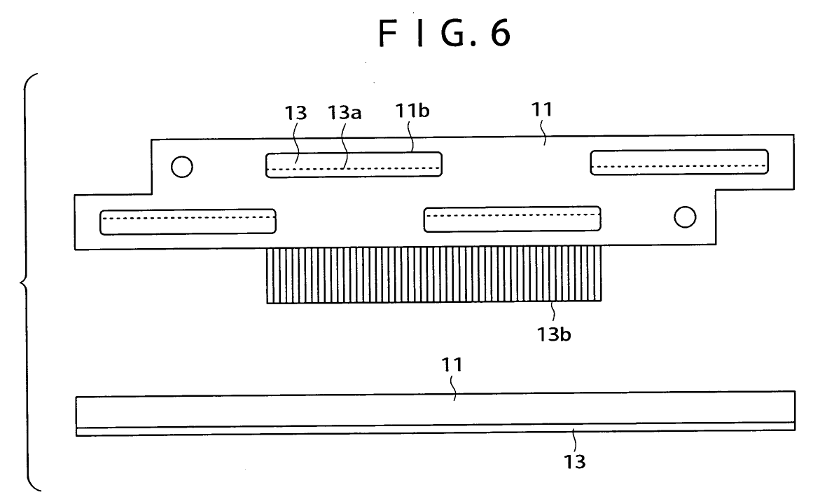

Subsequently, the nozzle sheet 13 located in the region of the head chip arranging hole 11b is provided with a nozzle array in which a number of the nozzles 13a corresponding to the number of the heat generating resistors 22 in one head chip 20 are arrayed in one direction. FIG. 6 shows a plan view showing the condition where the nozzle sheet 13 located in the head chip arranging hole 11b is provided with the array of nozzles 13a.

The nozzles 13a is formed by use of excimer laser. In addition, since the nozzle 13b formed by a laser beam is tapered, the formation of the nozzles 13a is conducted by irradiation with the laser beam from the side of the module frame 11. As a result, the nozzles 13a are each tapered so that the opening diameter thereof is gradually reduced as the ink jetting surface (the outside surface of the nozzle sheet 13) is approached.

In addition, the pitch of the nozzles 13a in the array of nozzles 13a formed in each head chip arranging hole 11b is made to be equal to the arrangement pitch of the heat generating resistors 22 of the head chip 20 (about 42.3 μm, in the case of manufacturing a head module 10 for a resolution of 600 dpi).

Furthermore, as shown in FIG. 6, the array of nozzles 13a in each head chip arranging hole 11b is so formed that the line connecting the array of nozzles 13a in each head chip arranging hole 11b (the line passing through the centers of the nozzles 13a) is located on the side of the center line of the module frame 11 drawn in parallel to the longitudinal direction of the module frame 11. Besides, let the head chip arranging holes 11b be N-th, (N+1)th, (N+2)th, and (N+3)th in this order from the left side, the arrays of nozzles 13a in the N-th one and the (N+2)th one of the head chip arranging holes 11b are so formed as to be aligned on one straight line parallel to the center line. This applies also to the (N+1)th one and the (N+3)th one of the head chip arranging holes 11b.

Therefore, the arrays of nozzles 13a in the adjacent head chip arranging holes 11b, for example, the arrays of nozzles 13a in the N-th one and the (N+1)th one of the head chip arranging holes 11b, are aligned on two straight lines parallel to the above-mentioned center line.

Incidentally, while one module frame 11 is provided with four head chip arranging holes 11b in this embodiment, the above-mentioned relationships are maintained also when the number of the head chip arranging holes 11b in one module frame 11 is greater than that in this embodiment.

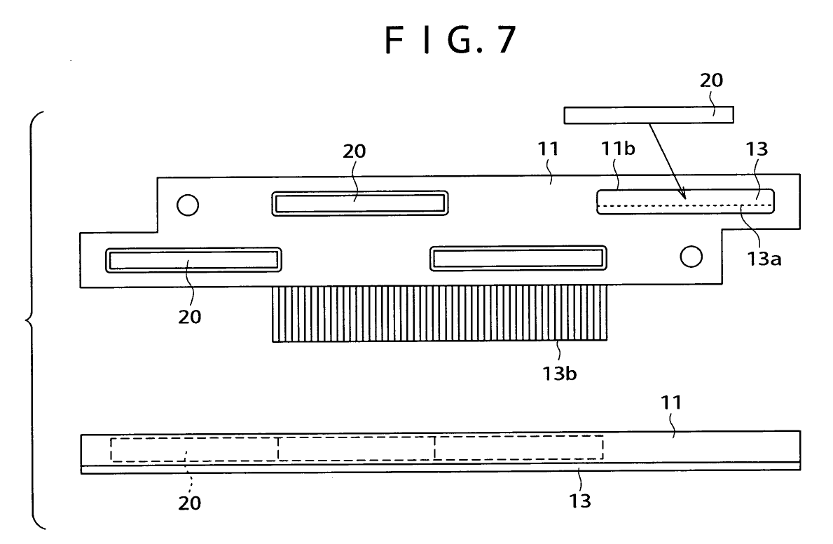

Next, as shown in FIG. 7, the head chip 20 with the barrier layer 12 laminated thereon is arranged and fixed in each head chip arranging hole 11b. Here, the head chip 20 is thermo compression bonded while being aligned by use of a chip mounter. In this case, further, the thermo compression bonding is carried out with an accuracy of, for example, about ±1 μm so that the nozzles 13a are located just under the heat generating resistors 22 of the head chip 20.

Here, taking into account the temperature variations of thermal expansion and the like, it is preferable that the head chip 20 and the module frame 11 have nearly equal coefficients of linear expansion. This ensures that, upon variations in temperature, the head chip arranging hole 11b is elongated and contracted due to the elongation and contraction of the module frame 11, and the head chip 20 arranged therein is also elongated and contracted at the same ratio as that of the elongation and contraction of the head chip arranging hole 11b, so that no thermal stress is exerted on the contact portion between the head chip 20 and the module frame 11.

In addition, the coefficient of linear expansion of the nozzle sheet 13 is greater than that of the head chip 20. Besides, the thermo compression bonding temperature of the head chip 20 is lower than the bonding temperature for bonding the module frame 11 and the nozzle sheet 13. Therefore, at the time of the thermo compression bonding of the head chip 20, the nozzle sheet 13 bonded to the module frame 11 is in the state of being stretched, so that deflection of the nozzle sheet 13 can be prevented, and flatness can be secured.

When the head chip 20 provided with the barrier layer 12 is thus arranged in the head chip arranging hole 11b and the nozzle sheet 13 and the head chip 20 are adhered to each other, the ink chambers 14 are formed by the surface of the nozzle sheet 13 on the side of the head chip 20, the barrier layer 12, and the surface where the heat generating resistors 22 are formed of the head chip 20.

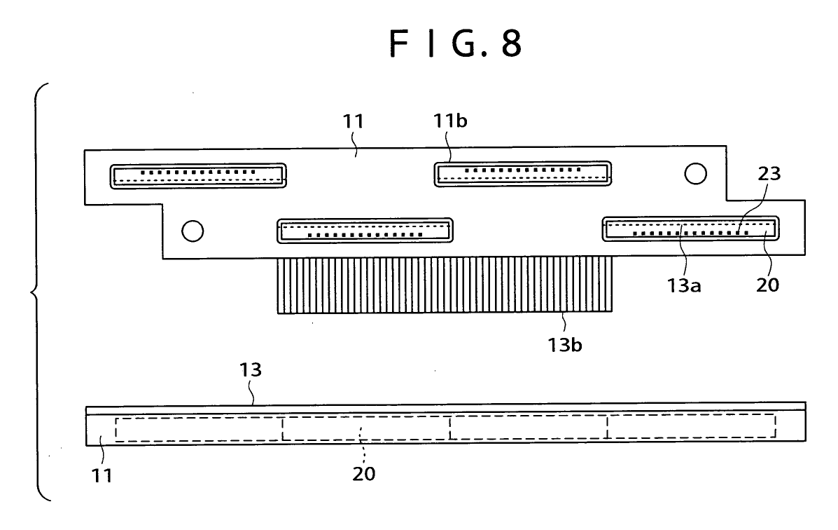

Subsequently, the connection pads 23 provided on the side of the head chips 20 and electrodes 13c (a plating layer having an outermost surface formed of gold) of the wiring pattern portion 13b on the side of the nozzle sheet 13 are electrically connected. FIG. 8 shows a plan view showing the arrangement of the connection pads 23 on the side of the head chips 20.

Incidentally, in FIG. 8, the nozzles 13a and the connection pads 23 are indicated by solid lines. As shown in FIG. 8, one head chip 20 is preliminarily provided with a plurality of connection pads 23 along the longitudinal direction of the head chip 20. Incidentally, in FIG. 2 referred to above, the positional relationship between the connection pad 23 and the wiring pattern portion 13b of the nozzle sheet 13 is shown in section.

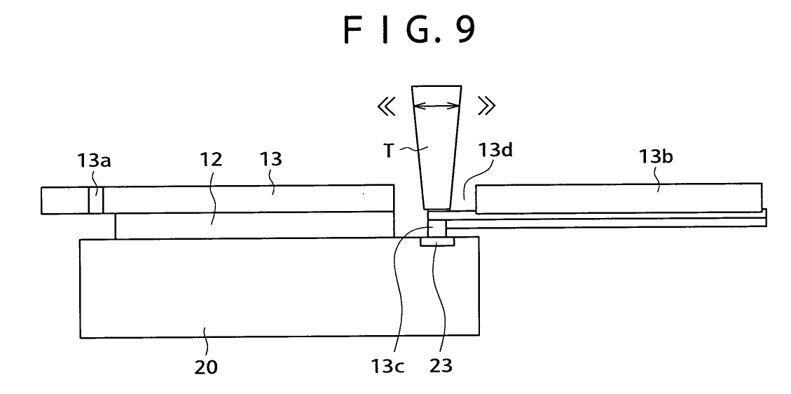

FIG. 9 is a side sectional view for illustrating the method of connecting the connection pad 23 of the head chip 20 and the electrode 13c of the wiring pattern portion 13b of the nozzle sheet 13.

As shown in FIGS. 2 and 9, the nozzle sheet 13 located in the region of the head chip arranging hole 11b of the module frame 11 is provided with the electrode 13c at the tip end of the wiring pattern portion 13b. Further, an opening portion 13d is provided in the surroundings of the electrode 13c of the nozzle sheet 13.

Then, as shown in FIG. 9, a pin-shaped vibrating tool T is inserted through the opening portion 13d in a surface, on the opposite side of the surface where the module frame 11 adhered, of the nozzle sheet 13, and ultrasonic vibration is applied to the vibrating tool T, whereby metallic bonding between the connection pad 23 and the electrode 13c of the wiring pattern portion 13b is achieved. After the bonding, the opening portion 13d is sealed with a resin (see FIG. 2). As shown in FIG. 2, after the sealing, the surface of the resin is substantially flush with the surface of the nozzle sheet 13 (the resin is not raised from the surface of the nozzle sheet 13).

Incidentally, as shown in FIG. 2, a printed wiring board 31 is provided on the wiring pattern portion 13b of the nozzle sheet 13, and a conductor 31a is provided on a surface, opposed to the wiring pattern portion 13b, of the printed wiring board 31. The conductor 31a and a wiring of the wiring pattern portion 13b are electrically connected to each other. As a result, electrical connection between the heat generating resistor 22 and the printed wiring board 31 (between the heat generating resistor 22 and the connection pad 23, between the connection pad 23 and the wiring pattern portion 13b, and between the wiring pattern portion 13b and the printed wiring board 31) is achieved.

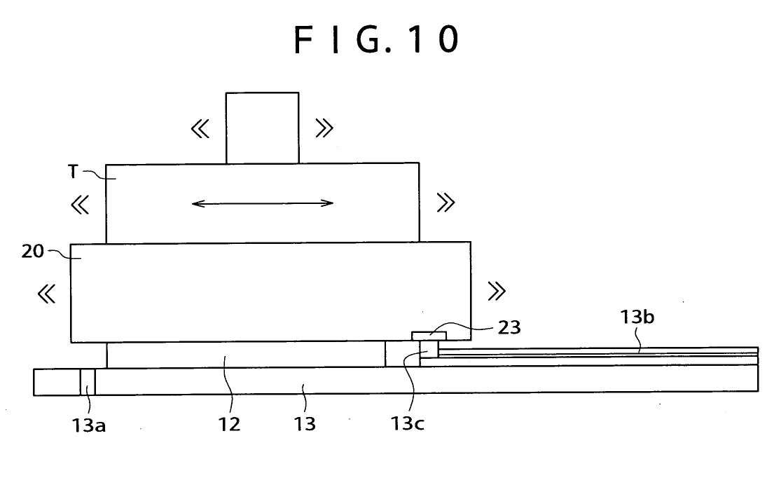

FIG. 10 is a side sectional view showing another embodiment of ultrasonic bonding. FIG. 10 shows an example in which the nozzle sheet 13 is not provided with opening portions for ultrasonic bonding. In this case, as shown in FIG. 10, the vibrating tool T is brought into direct contact with the head chip 20 from the side of the module frame 11 through the head chip arranging hole 11b, and ultrasonic waves are exerted on the head chip 20 (ultrasonic flip chip). This method also provides ultrasonic bonding between the connection pad 23 of the head chip 20 and the electrode 13c of the wiring pattern portion 13b, in the same manner as above. In this case, since vibration is applied to the side of the head chip 20, it is unnecessary to form the opening portion 13d, and resin sealing is not needed.

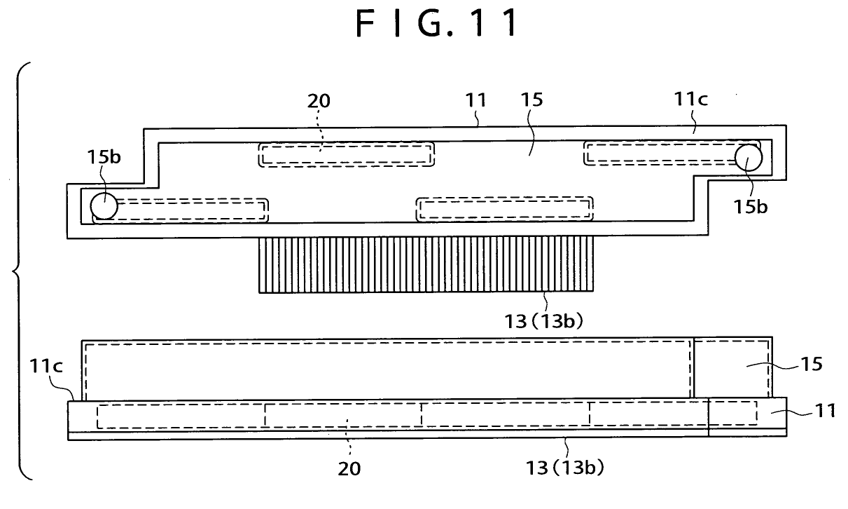

Next, a buffer tank 15 is mounted from the side of the module frame 11. FIG. 11 shows a plan view and a front view showing the condition where the buffer tank 15 is mounted. FIG. 12 is a side sectional view showing the condition where the buffer tank 15 is mounted.

One buffer tank 15 is provided for one head module 10. Besides, as shown in FIG. 11, the buffer tank 15 is slightly smaller than the module frame 11, as viewed in plan view, and the module frame 11 has the flange portion 11c; in this case, the buffer tank 11 is substantially similar in shape to the module frame 11. Further, as shown in FIG. 12, a common liquid conduit 15a as a vacancy is formed in the inside of the buffer tank 15. Particularly, the buffer tank 15 in this embodiment is opened on the lower side (on the side of the surface for adhesion to the module frame 11), has side walls and the ceiling wall in the same thickness, and roughly U shaped in section, thereby forming the common liquid conduit 15a.

As shown in FIG. 12, the edge on the lower side of the buffer tank 15 and the module frame 11 are adhered to each other by an adhesive. When the buffer tank 15 is mounted on the module frame 11, as shown in FIG. 11, the buffer tank 15 covers all the head chip arranging holes 11b.

Further, as shown in FIG. 12, the common liquid conduit 15a of the buffer tank 15 and the ink liquid chambers 14 of each head chip 20 are communicated with each other through the conduit 16 formed between the head chip arranging hole 11b and the head chip 20. As a result, the buffer tank 15 forms the common liquid conduits 15a for all the head chips 20 in the head module 10.

In addition, as shown in FIG. 11, the ceiling wall of the buffer tank 15 is provided with holes 15b, and an ink is supplied from an ink tank (not shown) into the common liquid conduit 15a through the holes 15b.

Here, as shown in FIG. 12, an inside edge (portion A, in FIG. 12) on the lower side of the buffer tank 15 is formed in a projected shape in section, and this projection-shaped portion comes into contact with the module frame 11. An adhesive is put on the outside (the portion stepped relative to the projection-shaped portion; portion B in FIG. 12) of the projection-shaped portion, for adhesion. As a result, the inside surface of the buffer tank 15 is not fitted into the head chip arranging hole 11b, so that the upper surface of the head chip 20 entirely comes into contact with the ink in the common liquid conduit 15a. In addition, the module frame 11 and the buffer tank 15 can be easily adhered to each other, and the shape of the buffer tank 15 can be simplified. Besides, the projection-shaped portion of the inside edge comes into contact with the module frame 11 on the lower side of the buffer tank 15, whereby the adhesive can be prevented from entering into the inside (the side of the common liquid conduit 15a and the head chip 20).

Incidentally, in the case of forming the common liquid conduit 15a on the upper side of the head chip 20 and sealing the upper side of the head chip 20, if the amount of the adhesive is too large, for example, the adhesive may enter into the ink liquid chambers 14, thereby clogging the ink liquid chambers 14. On the other hand, if the amount of the adhesive is too small, perfect sealing of the upper side of the head chip 20 cannot be achieved, so that ink leakage may occur. In view of this, it has been necessary to sufficiently control the amount of the adhesive applied. On the other hand, in this embodiment, as above mentioned, the buffer tank 15 does not enter into the head chip arranging hole 11b of the module frame 11, and is not adhered to the head chip 20 or the nozzle sheet 13 but is adhered only to the module frame 11. This shape unnecessitates a high-level technique of applying the adhesive, and ensures easy control of the adhesive application. In addition, it is possible to reduce the frequency of generation of defects attendant on the adhesive application.

In the manner mentioned above, the head module 10 is completed. In the head module 10 in this embodiment, the nozzle sheet 13 located in the head chip arranging holes 11b does not make contact with (is not adhered to) other component parts than the head chip 20, so that no unnecessary stress is exerted on the nozzle sheet 13. Therefore, it is possible to secure flatness of the back side of the nozzles 13a and a high positional accuracy of the nozzles 13a.

In addition, in the head module 10 in this embodiment, the buffer tank 15 is slightly smaller than and substantially similar in shape to the module frame 11, as viewed in plan view (see FIG. 11). Specifically, the module frame 11 has the flange portion 11c, and it is securely provided with a maximum size. Besides, as viewed in sectional view (see FIG. 12), the inside surface of the buffer tank 15 is roughly reverse U-shaped so as not to be fitted into the head chip arranging holes 11b. In other words, the whole upper surface of the head chip 20 constitutes the bottom wall of the common liquid conduit 15a.

Therefore, the amount of the ink in the common liquid conduit 15a is largely increased, and the head chip 20 can be cooled efficiently. Specifically, while a pulse current is passed to rapidly heat the heat generating resistor 22 for jetting the ink through the nozzle 13a, a higher-temperature environment has adverse effects on the performance, life, and troubles of the head chip 20. In view of this, it is necessary to protect the head chip 20 by constantly cooling the head chip 20. However, since the heat capacity is increased by the increase in the amount of the ink and heat is radiated from the whole upper surface of the head chip 20, it is unnecessary to operate a cooling system consisting in circulating the ink. In addition, the ink in the common liquid conduit 15a is prevented from being denatured due to a high temperature, stable supply of the ink is achieved, and it is possible to suppress print troubles such as ink blurring on the printed matter.

Further, in this embodiment, a plurality of the above-mentioned head modules 10 are used to construct one liquid jetting head 1.

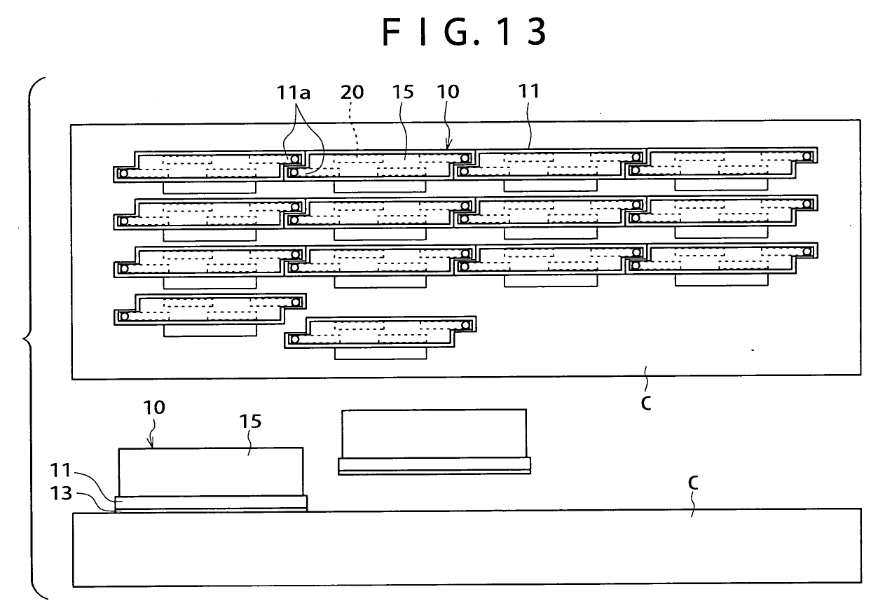

FIG. 13 shows a plan view and a front view showing the condition where the head modules 10 are arranged. In FIG. 13, the plan view shows a plurality of the head modules 10, while the front view shows the condition where one head module 10 is arranged.

In this embodiment, as shown in the plan view in FIG. 13, four head modules 10 are aligned in series on a base jig C. The base jig C is preferably provided with alignment marks (not shown). Using the alignment marks as references, each of the head modules 10 is disposed at a predetermined position. In this case, the head modules 10 are so arranged that the engaging portions 11a at both ends of the head modules 10 are engaged with each other, i.e., that the portions cut out in roughly L shape are connected to each other. In addition, the base jig C is preferably provided thereon with a pressure sensitive adhesive sheet D, since the head module 10 mounted on the base jig C can be maintained at the mounted position by the tack of the pressure sensitive adhesive sheet D. Incidentally, a UV sheet (a sheet having the function of loosing the tack upon irradiation with UV rays) can be used as the pressure sensitive adhesive sheet D.

With the four head modules 10 thus arrayed in a row, a line head for A4 form is constructed. Furthermore, the arrays of head modules 10 (each array consists of four head modules 10) are arranged in four rows (the plan view in FIG. 13 shows the condition where the head modules 10 are arranged in three rows, and, in the array of the head modules 10 in the lowest row, one head module 10 is mounted on the base jig C), to construct a color line head for printing in four colors Y, M, C, and K.

In addition, when a plurality of head modules 10 are thus mounted on the base jig C, the ink droplet jetting surfaces (the surface on the opposite side of the surface of adhesion to the module frame 11) of the nozzle sheets 13 in the head modules 10 are located on the same plain surface (the top surface of the base jig C).

Incidentally, let the two head modules 10 connected in series be head module “N” (left side) and head module “N+1” (right side) and let the four head chips 20 in each of the head modules “N” and “N+1” be 20A, 20B, 20C, and 20D in this order from the left side, the head chip 20D of the head module “N” and the head chip 20A of the head module “N+1” are so disposed that at least one nozzle 13a overlaps with the at least one corresponding nozzle 13a in the arrangement direction of the head chips 20. Specifically, the nozzle 13a, located nearest to the head module “N+1”, of the head chip 20D of the head module “N” is located on the right side relative to the nozzle, located nearest to the head module “N”, of the head chip 20A of the head module “N+1”.

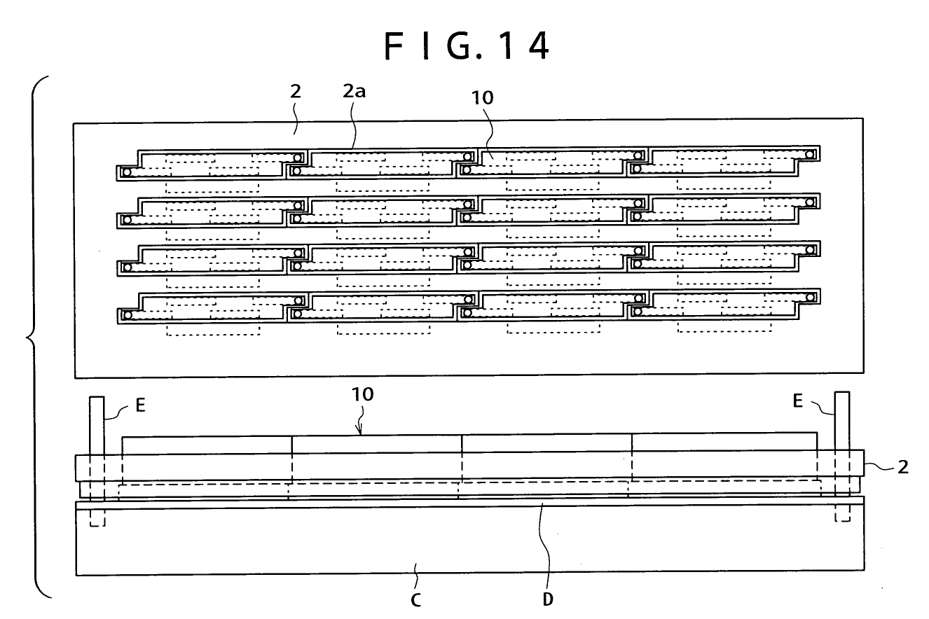

FIG. 14 shows a plan view and a front view showing the step of mounting the head frame 2.

After the units each consisting of four head modules 10 are arranged in four rows as above-mentioned, the head frame 2 is arranged from the upper side. The head frame 2 is formed of a high-rigidity metallic plate or the like, and is provided with four head module arranging holes 2a so that the four head modules 20 arranged in series can be arranged in each thereof. Specifically, the head module arranging holes 2a are each formed so that, when the head frame 2 is arranged from the upper side onto the four head modules 10 arranged as shown in FIG. 13, the four head modules 10 are placed in the inside thereof.

In addition, as shown in FIG. 14, at the time of arranging the head frame 2, the base jig C is provided thereon with pins E for positioning the head frame 2. On the other hand, the head frame 2 is provided with holes (not shown) for insertion of the pins E therein, and using the pins E as references, the head frame 2 is positioned relative to the head modules 10.

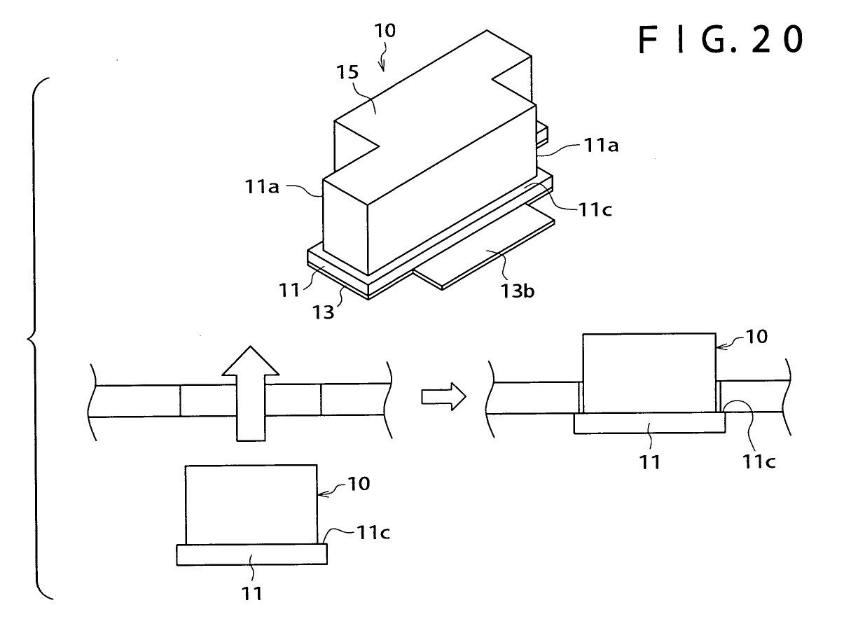

FIG. 20 illustrates the procedure of another technique for adhering the head modules 10 into the head module arranging hole 2a of the head frame 2.

As shown in FIG. 20, the module frame 11 of the head module 10 is provided with the flange portion 11c entirely projecting from the outside surface of the buffer tank 15. The size of the head module arranging hole 2a is slightly greater than the size of the buffer tank 15 and slightly smaller than the module frame 11.

Therefore, when the head modules 10 are inserted in the head module arranging hole 2a, the head modules 10 are aligned by the flange portions 11c, and is positioned in the vertical direction.

Accordingly, since it suffices for the base jig C (see FIG. 13) to position the head modules 10 in the left-right direction, the positioning can be simplified from three-dimensional positioning to the two-dimensional positioning. Incidentally, the flange portion 11c may partly project from the outside surface of the buffer tank 15. This applies also to the case of the step in FIG. 14.

When the head frame 2 is disposed in this manner, the condition shown in FIG. 1 is obtained, whereby the liquid jetting head 1 is assembled. In addition, as shown in the side view along arrow X in FIG. 1, the buffer tanks 15 of the head modules 10 do not make contact with the head module arranging holes 2a, whereas the module frames 11 of the head modules 10 and the head frame 2 make contact with each other, and are adhered to each other, whereby the head frame 2 and the head modules 10 are fixed.

Incidentally, while both members are adhered by an adhesive in this embodiment, an adhering (connecting) method not using an adhesive may be adopted.

Incidentally, as shown in the side view along arrow X in FIG. 1, before the head frame 2 is adhered to the head modules 10, the printed wiring board 3 is adhered to the lower side of the head frame 2 in a separate step. The printed wiring board 3 is so formed as to avoid the head module arranging holes 2a of the head frame 2, as viewed in plan view. Besides, as shown in the side view along arrow X in FIG. 1, the printed wiring board 3 does not make contact with the module frames 11 of the head modules 10 but is disposed between the module frames 11 of the head modules 10.

While the module frames 11 and the buffer tanks 15 are adhered by an adhesive in the above-described embodiment, a joining method not using an adhesive may also be used; for example, where both members are formed of weldable materials, they may be joined by welding.

Further, in this embodiment, for joining between the module frames 11 and the head frame 2 and joining between the module frames 11 and the buffer tanks 15, a thermally conductive adhesive may be used. A thermally conductive adhesive is prepared by adding a powder of a metal or oxide high in thermal conductivity to an adhesive, with a typical example thereof being an adhesive admixed with a powder of aluminum. Besides, there is also known a thermally conductive adhesive prepared by adding beryllium oxide, which is higher than aluminum in thermal conductivity. Specific examples include a silver-loaded epoxy based adhesive having a thermal conductivity of 1 to 4 W/m·K, an aluminum (50)-loaded epoxy based adhesive having a thermal conductivity of 1 to 2 W/m·K, and an alumina (75 wt %)-loaded epoxy based adhesive having a thermal conductivity of 0.8 to 1 W/m·K. Incidentally, there is no clear definition about how high the thermal conductivity of an adhesive must be for the adhesive to be called a thermally conductive adhesive; in the present invention, those adhesives having a thermal conductivity of 0.8 W/m·K or above are defined as thermally conductive adhesives, and adhesives conforming to the definition can be used.

Incidentally, the head frame 2 preferably has a coefficient of linear expansion comparable (substantially equivalent) to that of the module frames 11. For example, the material of the head frame 2 is the same as the material (e.g., invar steel mentioned above) of the module frames 11. As above-mentioned, the module frames can be formed of alumina ceramic; in this case, the head frame 2 can be formed of alumina ceramic, but this is expensive. On the contrary, when the head frame 2 is formed of a metallic material, the cost is not high, and the heat of the head chips 20 is easily released to the side of the head frame 2, which is preferable. Naturally, the material of the head frame 2 may be different from the material of the module frames 11, as long as both the materials have nearly equal coefficients of linear expansion.

Therefore, where the head frame 2 and the module frames 11 are formed of materials having nearly equal coefficients of linear expansion, no thermal stress is exerted on the adhesive even upon variations in temperature, so that the adhesive can be prevented from exfoliation. Particularly where the members having different coefficients of linear expansion are adhered by an adhesive, it is necessary to use an adhesive which is flexible (low in Young's modulus) even after curing thereof, in view of the differences in elongation and contraction attendant on variations in temperature. According to this embodiment, on the other hand, there is no limitation as to the Young's modulus after curing of the adhesive.

In addition, with the head frame 2 and the module frames 11 adhered by a thermally conductive adhesive, the heat generated on the side of the head chips 2 can be efficiently transferred to the side of the head frame 2 through the module frames 11, so that the heat of the head chips 20 can be efficiently released to the side of the head frame 2.

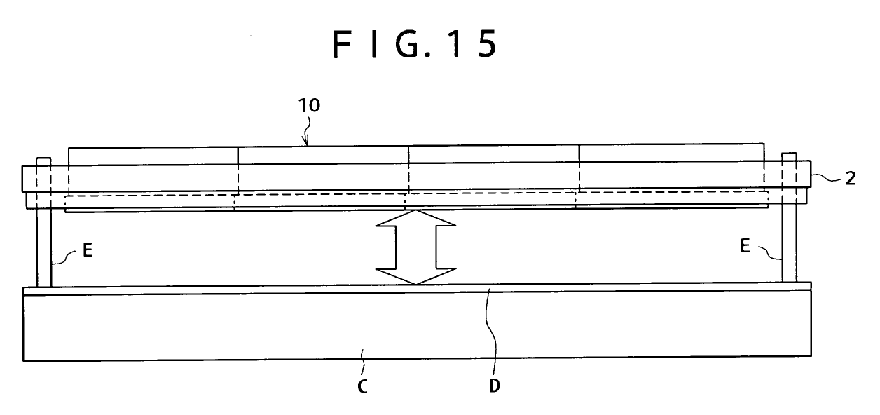

FIG. 15 is a front view showing the manner in which the head frame 2 and the head modules 10 in an integral state are separated from the base jig C.

As has been described above, the pressure sensitive adhesive sheet D is provided on the base jig C, the tack of the pressure sensitive adhesive sheet D is removed by irradiating the pressure sensitive adhesive sheet D with UV rays, and the head frame 2 and the head modules 10 in the integral state are easily separated from the base jig C. Here, at least the mounting surface of the base jig C for mounting the head modules 10 are formed of a transparent material (e.g., a glass or an acrylic plate), and irradiation with UV rays is conducted from the back side of the base jig C. At the time of separation, as shown in FIG. 15, the head frame 2 and the head modules 10 in the integral state are lifted up along the axial direction of the pins E.

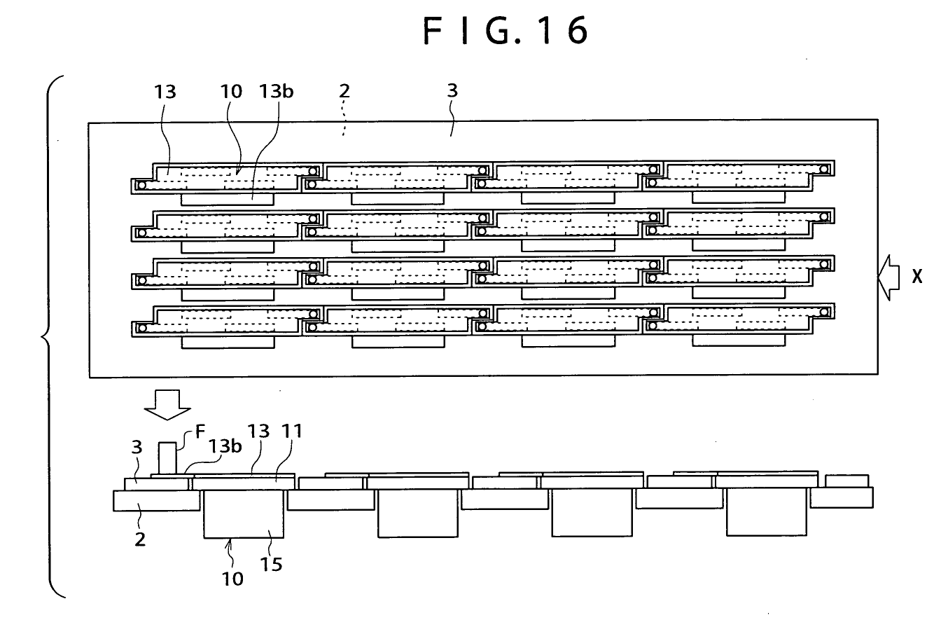

FIG. 16 shows a plan view and a side view along arrow X, for illustrating the next step for the head frame 2 and the head modules 10 adhered in the above-mentioned step. In FIG. 16, the head modules 10 are shown with the nozzle sheets 13 on the upper side, unlike in FIGS. 14 and 15.

When the head frame 2 and the head modules 10 are adhered in the above-mentioned manner, the wiring patterns 13b of the nozzle sheets 13 are laid on the wiring portions (not shown) of the printed wiring board 3 adhered to the head frame 2. Then, as shown in the side view along arrow X in FIG. 16, a heat bar F is applied from the upper side of the wiring pattern portions 13b, as viewed in the figure, and the wiring portions of the printed wiring board 3 and the wiring pattern portions 13b of the nozzle sheets 13 are soldered.

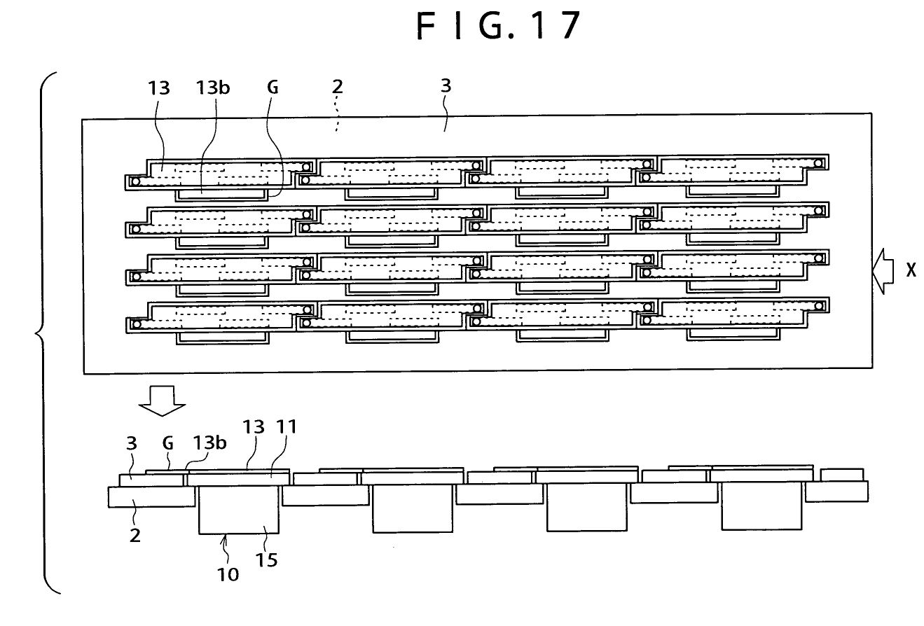

FIG. 17 shows a plan view and a side view along arrow X, for illustrating the step subsequent to the soldering step. After the wiring portions of the printed wiring board 3 and the wiring pattern portions 13b of the nozzle sheets 13 are soldered, as shown in FIG. 17, the soldered terminal portions are resin-coated (sealed) with a resin coating agent G so as to surround the edge portions of the wiring pattern portions 13b. As the resin coating agent G, for example, a silicone based resin is used.

Upon the above-mentioned steps, the condition as shown in FIG. 1 is obtained, whereby the liquid jetting head 1 is produced. Incidentally, as shown in the side view along arrow X in FIG. 1, the buffer tanks 15 of the head modules 10 do not make contact with the head module arranging holes 2a.

Meanwhile, when the head modules 10 are connected in series, a line head can be assembled. However, if the head modules 10 are merely connected and fixed by an adhesive, they are instable on a strength basis. As has been shown in this embodiment, therefore, the head frames 10 are securely fixed by use of the head frame 2, which functions as a support member for the head modules 10.

Although rigidity can be secured by the above-mentioned method, the adhesion between different members leads to the problem of thermal stress upon variations in temperature.

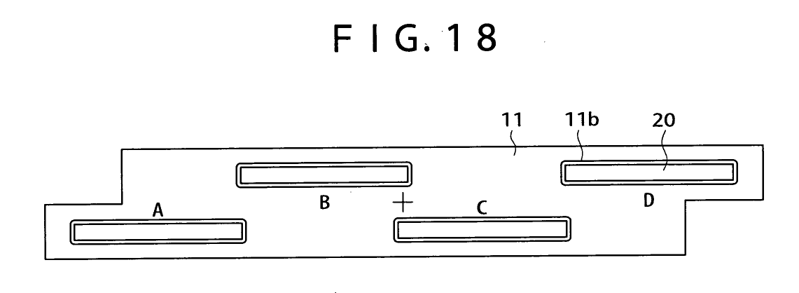

FIG. 18 is a plan view showing the head chips 20 and the module frames 11 in one head module 10. In the figure, the four head chips 20 are designated as A, B, C, and D (head chips 20A, 20B, 20C, and 20D) in this order from the left side.

Each of the head chips 20 is arranged in the head chip arranging hole 11b of the module frame 11, so that variations in relative positions of the head chips 20 due to temperature variations are governed by variations in the module frame 11.

First, it will be considered to what degree the distance (the interval between the nozzles 13a, i.e., 42.3 μm in the case of 600 dpi) between the rightmost nozzle 13a of the head chip 20B and the leftmost nozzle 13a of the head chip C in X direction (the longitudinal direction in FIG. 18, or the arrangement direction of the nozzles 3a) in FIG. 18 is varied attendant on variations in temperature.

Here, it is assumed that the material of the module frame 11 is SUS430, which has a linear expansion coefficient α of 10.4 ppm. In addition, the linear expansion coefficient α of the head chip 20 (silicon) is assumed to be 2.4 ppm. Further, it is assumed that each head chip 20 is provided with 320 heat generating resistors 22, the total interval thereof being 42.3 μm×319=13.4937 mm. It is assumed that normal temperature is raised from 25° C. (room temperature) to 80° C.

In this instance, the above-mentioned distance is changed by an amount corresponding to the difference in linear expansion coefficient between the head chip 20 and the module frame 11. The elongation/contraction amount is
13.4937×(80−25)×(10.4−2.4)×10⁻⁶=5.94×10⁻³ mm. (Formula 1)

Therefore, considering the head chips 20B and 20C, the positions of the heat generating resistors 22 in the head chips 20 are shifted by about 3 μm on each side, with the mark “+” in FIG. 18 as a center. Namely, the above-mentioned distance is enlarged by about 6 μm.

Here, considering the linear expansion coefficient α for the purpose of restraining the misregistration (elongation/contraction amount) due to the temperature variation (temperature rise from 25° C. to 80° C.) to 2 μm or below,
13.4937×(80−25)×(α−2.4)×10⁻⁶=2×10⁻³ mm (Formula 2)

hence

α=5.1 ppm.

Therefore, it is necessary for the material of the module frame 11 to have a linear expansion coefficient of not more than 5.1 ppm.

Furthermore, the elongation/contraction in Y direction (direction orthogonal to the X direction) due to temperature variations is as follows.

The spacing between the head chips 20A and 20B, the spacing between the head chips 20B and 20C, and the spacing between the head chips 20C and 20D are varied due to temperature variations of the module frame 11. For example, let the spacing between heat generating resistors 22 in Y direction between the head chips 20 be 5 mm, then the elongation/contraction due to the temperature variation of the module frame 11 is calculated, in the same manner as in the case of X direction, as follows:
5×(80−25)×10.4×10⁻⁶=2.86×10⁻³ mm. (Formula 3)

In addition, where the material has a linear expansion coefficient α of 5.1 ppm, the elongation/contraction amount is calculated in the same manner as above, to be 1.4 μm.

Next, elongation/contraction due to temperature variations between the head modules 10 will be described.

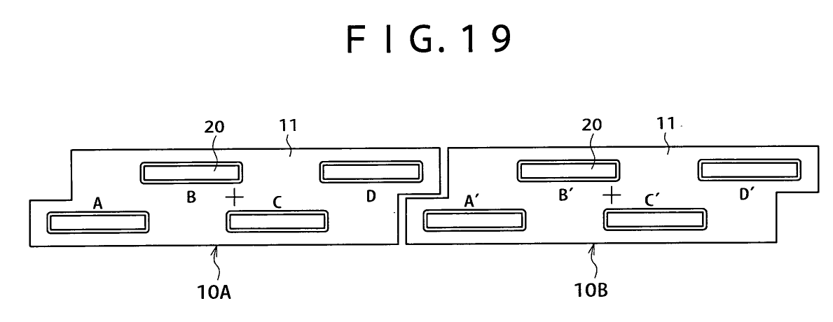

FIG. 19 is a plan view showing two head modules 10 adjacent to each other. In FIG. 19, the head module 10 on the left side is named 10A, and the head module 10 on the right side is named 10B. Besides, in the head module 10A, the four head chips 20 are respectively designated as A, B, C, and D (head chips 20A to 20D) in this order from the left side, in the same manner as in FIG. 18, and, in the head module 10B, the four head chips 20 are respectively designated as A′, B′, C′, and D′ (head chips 20A′ to 20D′).

Where the material of the head frame 2 is the same as the material of the module frames 11, the head frame 2 and the module frames 11 are elongated and contracted in the same manner upon variations in temperature, which is preferable. As has been described above, the material of the module frames 11 must have a linear expansion coefficient of 5.1 ppm or below, it suffices to set the linear expansion coefficient of the head frame 2 accordingly.

Here, the case where the material of the head frame 2 has a linear expansion coefficient different from that of the module frames 11 will be considered.

Where the linear expansion coefficients of both of the frames are different, both the frames show different elongation/contraction characteristics upon variations in temperature. In FIG. 19, attention is paid to the spacing between the heat generating resistor 22 at the right end (in the figure) of the head chip A in the head module 10A and the heat generating resistor 22 at the left end (in the figure) of the head chip 20A′ in the head module 10B.

First, the distance from the center of the head module 10A to the center of the head chip 20D of the head module 10A is 20.304 mm, and the elongation and contraction of this distance due to temperature variations are governed by the elongation and contraction of the module frame 11.

In addition, the distance from the center of the head chip 20D in the head module 10A to the heat generating resistor 22 at an end portion is 6.747 mm, and the elongation and contraction of this distance is governed by the elongation and contraction of the head chip 20.

Here, it is assumed that the linear expansion coefficient α of the module frame 11 is 5.1 ppm, the linear expansion coefficient α of the head frame 2 is 10.4 ppm (SUS430), and the linear expansion coefficient α of the head chip 20 is 2.4 ppm (silicon). When it is also assumed that temperature is raised from normal temperature (room temperature) of 25° C. to 80° C., the elongation/contraction amount is given as follows:
20.304×(80−25)×5.1×10⁻⁶+6.747×(80−25)×2.4×10⁻⁶=6.59×10⁻³ mm. (Formula 4)

On the other hand, similar calculation as to the head frame 11 gives the following:
(20.304+6.747)×(80−25)×10.4×10⁻⁶=15.47×10⁻³ mm. (Formula 5)

Therefore, the head frame 2 is elongated by the difference between Formula 4 and Formula 5, namely, 8.88 μm. Accordingly, the distance between the right end heat generating resistor 22 of the head chip 20D in the head module 10A and the left end heat generating resistor 22 of the head chip 20A′ in the head module 10B is enlarged by 17.76 μm.

Thus, where the linear expansion coefficient of the head frame 2 is different from that of the module frames 11, the distance between the heat generating resistors 22 in the adjacent head modules 10 is varied. Therefore, it is necessary that the linear expansion coefficient of the head frame 2 is substantially equal to the linear expansion coefficient of the module frame 11. Accordingly, for example, where both frames are made of the same material, the linear expansion coefficients of both of them can be made equal to each other.

From the foregoing, it is desirable that the linear expansion coefficient of the module frames 11 be substantially equal to the linear expansion coefficient of the head chips 20, and, further, it is desirable that the linear expansion coefficient of the head frame 2 be substantially equal to the linear expansion coefficient of the module frames 11.

In addition, it is preferable that the module frames 11 and the buffer tanks 15 have nearly equal (substantially equal) coefficients of linear expansion. For example, both of them may be formed of the same material. Naturally, the module frames 11 and the buffer tanks 15 may not necessarily be formed of the same material, as long as they have nearly equal coefficients of linear expansion.

Thus, with the module frames 11 and the buffer tanks 15 set to have nearly equal coefficients of linear expansion, no thermal stress is exerted on the adhesive even upon variations in temperature, so that it is possible to prevent exfoliation of the adhesive and, hence, to prevent leakage of the ink. Particularly, in the case where members having different coefficients of linear expansion are adhered to each other by an adhesive, an adhesive which is flexible (low in Young's modulus) even after curing must be used, in consideration of the differences in elongation and contraction upon variations in temperature. On the other hand, where members having nearly equal coefficients of linear expansion are adhered to each other by an adhesive, there is no limitation regarding the Yong's modulus after curing of the adhesive.

In addition, with the module frames 11 and the buffer tanks 15 adhered by a thermally conductive adhesive, the heat generated on the side of the head chips 20 can be efficiently transferred to the side of the buffer tanks 15 through the module frames 11, so that the heat of the head chips 20 can be efficiently released. Particularly, by releasing the heat to the buffer tanks 15, a cooling effect by the ink in the buffer tanks 15 can be obtained.

Incidentally, where the adhesive is poor in thermal conductivity, a temperature difference may be generated between the module frames 11 and the buffer tanks 15 during the process of temperature rise, possibly resulting in warping of the entire body. Therefore, it is desirable to contrive a swift thermal equalization, and, hence, it is preferable to use a thermally conductive adhesive.

While one embodiment of the present invention has been described above, the present invention is not limited to the above embodiment, and the following various modifications are possible, for example.

(1) In the above embodiment, the module frame 11 has been provided with four head chip arranging holes 11b so that four head chips 20 are mounted in one head module 10. This configuration is not limitative, and any number of head chips 20 may be mounted in one head module 10.

(2) In the case of assembling the liquid jetting head 1 as a line head, in the above embodiment, assemblies each including four head modules 10 have been arranged in four rows. This configuration is not limitative, and the number of the head modules 10 in one liquid jetting head 1 can be varied, according to the use of the liquid jetting head 1 or the number of colors. Here, in the cases where adhesion to the head frame 2 is not expected, such as the case where only one head module 10 is provided, a configuration may be adopted in which the flange portion 11c is not provided, and the plan view shape of the buffer tank 15 is the same as the outside shape of the module frame 11.

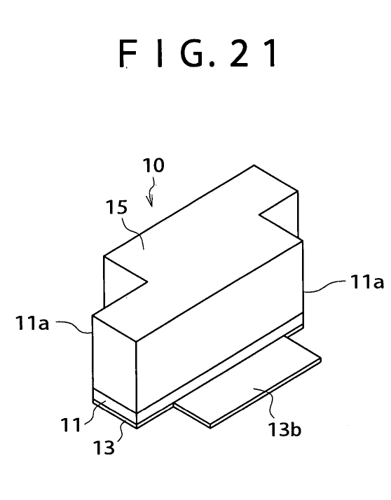

FIG. 21 is a perspective view showing another embodiment of the head module 10.

The head module 10 shown in FIG. 21 has a configuration in which the buffer tank 15 and the module frame 11 have the same outside shape, whereby the buffer tank 15 is enlarged more. Therefore, the amount of the ink temporarily reserved in the buffer tank 15 is increased further, thereby promising a further enhancement of cooling effect.

(3) While one liquid jetting head 1 has been presented as an example in the above embodiment, a plurality of liquid jetting heads 1, for example, can be connected in series to thereby assemble a larger liquid jetting head. In the case of connecting the liquid jetting heads 1 in series with each other, it may be contemplated to provide engaging portions for connecting the liquid jetting heads 1 in series, on both left and right sides of the head frame 2. Alternatively, a configuration may be adopted in which of the head modules 10 located at both left and right end portions of the liquid jetting head 1, the engaging portions of at least one head module 10 located at the left end portion and at least one head module 10 located at the right end portion are projected outwards from the head frame 2, and the projected engaging portions 11a of the head modules 10 are engaged with each other, whereby the liquid jetting heads 1 are connected in series with each other.

(4) While the pressure sensitive adhesive sheet D has been used for fixing the positions of the head modules 10 mounted on the base jig C in the above embodiment, this method is not limitative, and various other methods may be adopted. For example, a method may be adopted in which the base jig C fixes the positions of the head modules 10 by vacuum suction. In this case, the vacuum suction is released after the head frame 2 and the head modules 10 are adhered to each other.

Next, other embodiments of the present invention will be described. Incidentally, the description of the same portions as those in the above embodiment is omitted, and description will be made by use of the same drawings and the same symbols in the drawing as those used for the above embodiment.

The buffer tank 15 has the function of temporarily reserving the ink in the above embodiment, the buffer tank 15 can simultaneously be used as a support member for fixing the head chip 20.

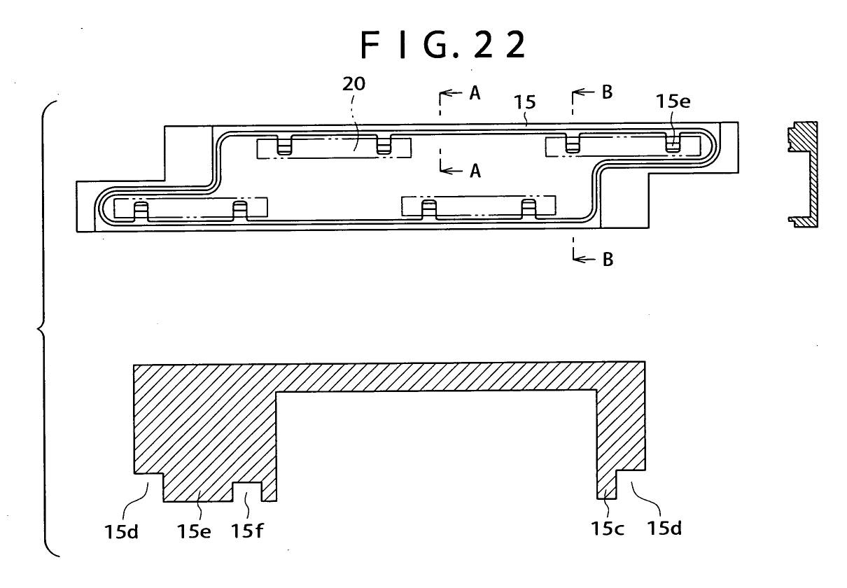

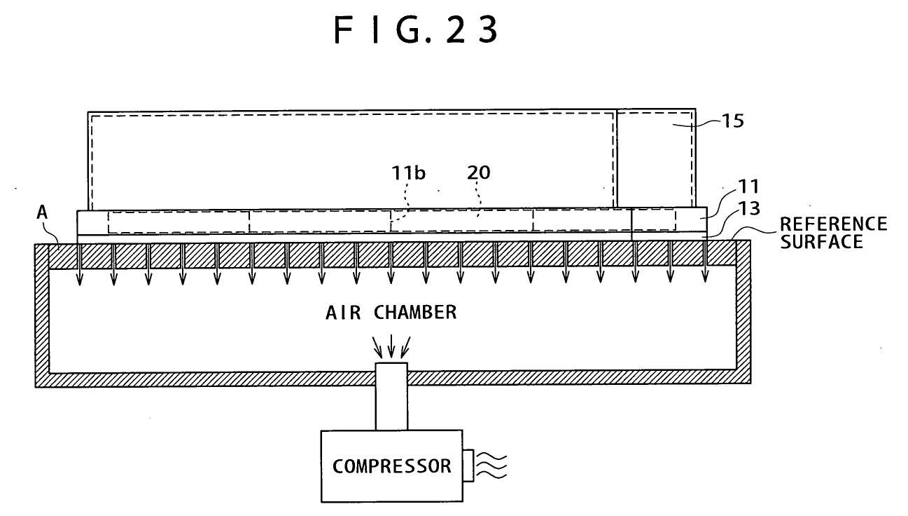

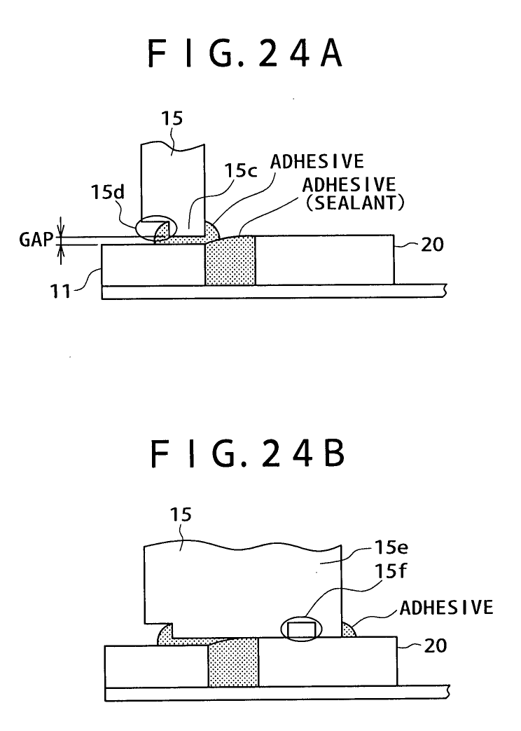

The buffer tank 15 forms the common liquid conduit 15a for all the head chips 20 and temporarily reserves the ink to be supplied into the ink liquid chambers 14, as described above. In this embodiment, particularly, the buffer tank 15 functions also as a rigid support member for fixing each of the head chips 20. Specifically, FIG. 22 shows a bottom view of the buffer tank 15, and an enlarged sectional view along line B-B. Besides, FIG. 23 illustrates the procedure of mounting the buffer tank 15. Further, FIGS. 24A and 24B show partial sectional views showing the condition where the buffer tank 15 is mounted, taken along line A-A and line B-B, respectively.

As shown in FIG. 22, the inside edge on the lower surface side of the buffer tank 15 is formed in a projected shape in section, and the outside of the projection-shaped portion 15c (the portion stepped relative to the projection-shaped portion 15c) constitutes a relief portion 15d for the adhesive. In addition, a fixing portion 15e for the head chip 20 is partially provided on the inside of a side wall of the buffer tank 15. Further, the fixing portion 15e is provided with a gap 15f.

In mounting the buffer tank 15, as shown in FIG. 23, the head chips 20 are first disposed in the head chip arranging holes 11b of the module frame 11, the nozzle sheet 13 and the head chips 20 are adhered, and this unit is mounted on the base jig A.

Here, the reference surface side of the base jig A is the nozzle sheet 13, and the nozzle sheet 13 is brought into close contact with the reference surface by vacuum suction, whereby the flatness of the nozzle sheet 13 is secured. Incidentally, the nozzle sheet 13 may be brought into close contact with the reference surface by a pressure sensitive adhesive sheet (which looses its tack when UV rays, heat or the like is applied thereto).

Thereafter, as shown in the sectional view along line B-B in FIG. 24B, the fixing portion 15e of the buffer tank 15 is abutted on the head chip 20. Then, the pre-applied adhesive is fed into the gap 15f of the fixing portion 15e to form an adhesive layer, and the buffer tank 15 and the head chip 20 are adhered to each other by the adhesive layer. Incidentally, as the adhesive, a normal temperature curable adhesive is preferably used, taking into account the warping or strain due to heat.

Besides, as shown in the sectional view along line A-A in FIG. 24A, a gap of about 0.14 mm is present between the projection-shaped portion 15c of the buffer tank 15 and the module frame 11, and the gap is filled with an adhesive, whereby the buffer tank 15 and the module frame 11 are adhered to each other. Here, since the relief portion 15d is provided on the outside of the projection-shaped portion 15c, the adhesive would not flow out to the outside of the buffer tank 15. Incidentally, the gap between the module frame 11 and the head chip 20 is clogged with an adhesive (sealant), whereby lead wiring (not shown) is insulated from the ink.

By this, the buffer tank 15 can be easily adhered, and can be adhered while securing the flatness of the nozzle sheet 13. Therefore, the flatness of the nozzle sheet 13 is secured even after the detachment from the base jig A, and, since the rigid buffer tank 15 serves as a support member to firmly fix each of the head chips 20, even when a plurality of head chips 20 are joined to one nozzle sheet 13, the flatness of the nozzle sheet 13 between the head chips 20 is maintained. Incidentally, for the detachment from the base jig A, the vacuum condition is released in the case of vacuum suction, and the tack is eliminated by UV rays, heat or the like in the case of the pressure sensitive adhesive sheet.

Besides, the module frame 11, the head chips 20, and the buffer tank 15 (support member) have comparable coefficients of linear expansion, for obviating the troubles such as exfoliation of the adhesive under the action of thermal stress, which troubles might occur if the coefficients of linear expansion differ largely.

In addition, in this embodiment also, a plurality of head modules 10 may be used to assemble one liquid jetting head 1.

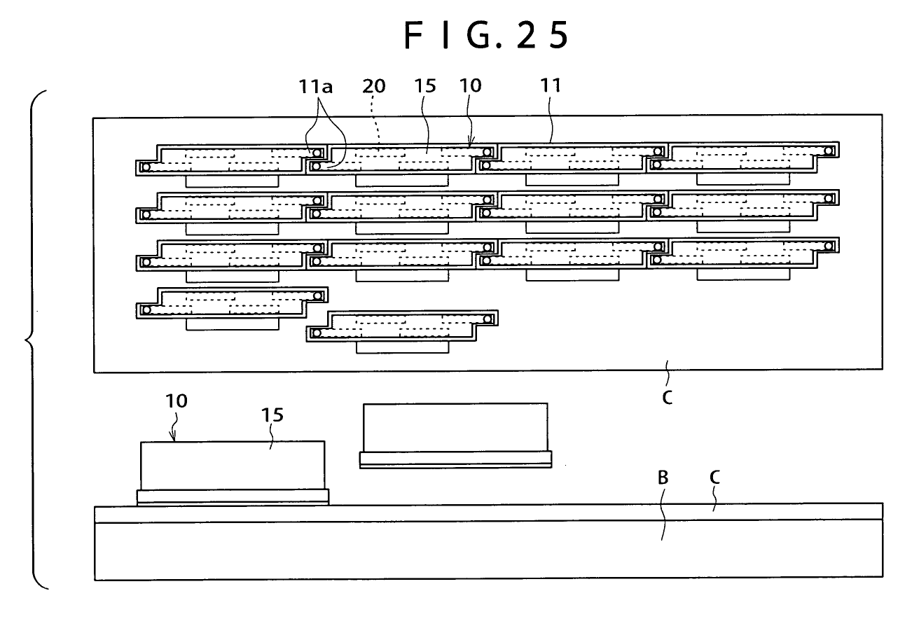

FIG. 25 shows a plan view and a front view showing the condition where the head modules 10 are arranged. In FIG. 25, a plurality of head modules 10 are shown in the plan view, whereas the condition where one head module 10 is arranged is shown in the front view.

In this embodiment also, like in the above-described embodiment, the pressure sensitive adhesive sheet C (which looses its tack when UV rays, heat or the like is applied thereto) is adhered to the base jig B, as shown in the front view in FIG. 25. Therefore, as shown in the plan view in FIG. 25, when the four head modules 10 are arranged in series on the base jig B, each of the head module 10 is brought into close contact with the base jig B. In this case, the head modules 10 are so arranged that the engaging portions 11a at both end portions of each head module 10 are engaged with each other, i.e., the portions cut out in a roughly L shape are connected to each other.

With the four head modules 10 thus aligned in a row, a line head for A4 form can be assembled, in the same manner as in the above-described embodiment. The same or similar points to those in the above-described embodiment will be omitted.

In the same manner as in the above-described embodiment, the units each including four head modules 10 arrayed in a row are arranged in four rows, then the head modules 10 are adhered to the head frame 2, and, finally, the tack of the pressure sensitive adhesive sheet C is removed by UV rays, heat, or the like and the resulting assembly is detached from the base jig B.

While the other embodiments of the present invention have been described above, the other embodiments are not limitative, and various modifications may be made, in the same manner as in the case of the above-described embodiment.

For example, while the buffer tank 15 for temporarily reserving the ink has been used as the support member for fixing the head chips 20, this configuration is not limitative; a conduit plate 17 provided with a fixing portion 17e for the head chip 20 and serving for forming a common liquid conduit 17a communicated with all the ink liquid chambers 14 of the head chip 20 may be used as the support member.

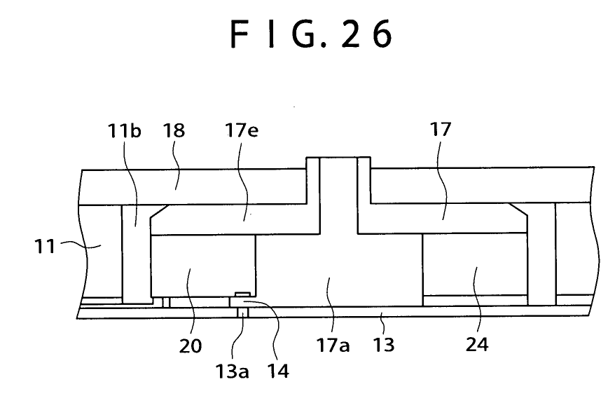

FIG. 26 is a side sectional view showing the condition where the conduit plate 17 is mounted. As shown in FIG. 26, the head chip 20 and a dummy chip 24 are arranged in the head chip arranging hole 11b of the module frame 11, and are respectively adhered to the nozzle sheet 13 (the head chip 20 is located on the side of the nozzles 13a). Then, the conduit plate 17 (fixing portion 17e) is mounted on the head chip 20 and the dummy chip 24, to form the common liquid conduit 17a, thereby supplying the ink into the ink liquid chambers 14. In addition, the conduit plate 17 is fixed to the rigid module frame 11 through a top plate 18. Therefore, the conduit plate 17 functions as a support member for the head chip 20, and the flatness of the nozzle sheet 13 is secured.

The present invention is not limited to the details of the above-described preferred embodiments. The scope of the invention is defined by the appended claims and all changes and modifications as fall within the equivalence of the scope of the claims are therefore to be embraced by the invention.

1-8. (canceled)

9. A method of manufacturing a head module which includes:
a head chip including a plurality of energy generating elements arranged at a fixed interval in one direction,
a nozzle sheet provided with nozzles for jetting liquid droplets,
a liquid chamber forming member laminated between the surface where said energy generating elements are formed of said head chip and said nozzle sheet so as to form a liquid chamber between each said energy generating element and each said nozzle, and
a module frame adhered to one side of said nozzle sheet to thereby support said nozzle sheet and provided with a head chip arranging hole for arranging said head chip therein,
a liquid in said liquid chambers being jetted through said nozzles by said energy generating elements, said method including:
a first step for adhering said module frame to said one side of said nozzle sheet,
a second step for providing said nozzle sheet located in the region of said head chip arranging hole with a nozzle array so that each said nozzle is disposed at a position opposed to each said energy generating element of said head chip when said head chip is disposed in the region of said head chip arranging hole,
a third step for arranging said head chip, provided with said liquid chamber forming member, in said head chip arranging hole so that each said energy generating element of said head chip and each said nozzle formed in said nozzle sheet located in the region of said head chip arranging hole are opposed to each other, and
a fourth step for arranging a buffer tank, which covers said head chip arranging hole from a surface, on the opposite side of the surface of adhesion to said nozzle sheet, of said module frame and which forms a common liquid conduit communicated with all said liquid chambers of said head chip, on said surface, on the opposite side of the surface of adhesion to said nozzle sheet, of said module frame.

10. A method of manufacturing a liquid jetting head which includes:
a plurality of head modules, and
a head frame provided with head module arranging holes for arranging therein said plurality of head modules disposed in series, said head frame adhered to each of said head modules arranged in said head module arranging holes,
each of said head modules including:
a head chip including a plurality of energy generating elements arrayed at a fixed interval in one direction,
a nozzle sheet provided with nozzles for jetting liquid droplets,
a liquid chamber forming member laminated between the surface where said energy generating elements are formed of said head chip and said nozzle sheet so as to form a liquid chamber between each said energy generating element and each said nozzle, and
a module frame adhered onto one side of said nozzle sheet to thereby support said nozzle sheet and provided with a head chip arranging hole for arranging said head chip therein,
a liquid in said liquid chambers being jetted through said nozzles by said energy generating elements, wherein
said head modules are each formed by a process including:
a first step for adhering said module frame to said one side of said nozzle sheet,
a second step for providing said nozzle sheet located in the region of said head chip arranging hole with a nozzle array so that each said nozzle is disposed at a position opposed to each said energy generating element of said head chip when said head chip is disposed in the region of said head chip arranging hole,
a third step for arranging said head chip, provided with said liquid chamber forming member, in said head chip arranging hole so that each said energy generating element of said head chip and each said nozzle formed in said nozzle sheet located in the region of said head chip arranging hole are opposed to each other, and
a fourth step for arranging a buffer tank, which covers said head chip arranging hole from a surface, on the opposite side of the surface of adhesion to said nozzle sheet, of said module frame and which forms a common liquid conduit communicated with all said liquid chambers of said head chip, on said surface, on the opposite side of the surface of adhesion to said nozzle sheet, of said module frame, and
said method further includes a fifth step for arranging said plurality of head modules formed by said fourth step in said head module arranging holes of said head frame and adhering each said module frame to said head frame, in the condition where said plurality of head modules are arranged in series.

11-21. (canceled)

22. A method of manufacturing a liquid jetting head which includes:
a plurality of head modules, and
a head frame provided with head module arranging holes for arranging therein said plurality of head modules disposed in series, said head frame adhered to each of said head modules arranged in said head module arranging holes,
each of said head modules including:
a head chip including a plurality of energy generating elements arrayed at a fixed interval in one direction,
a nozzle sheet provided with nozzles for jetting liquid droplets,
a liquid chamber forming member laminated between the surface where said energy generating elements are formed of said head chip and said nozzle sheet so as to form a liquid chamber between each said energy generating element and each said nozzle,
a module frame adhered onto one side of said nozzle sheet to thereby support said nozzle sheet and provided with a head chip arranging hole for arranging said head chip therein, and
a buffer tank laminated on a surface, on the opposite side of the surface of adhesion to said nozzle sheet, of said module frame, for forming a common liquid conduit communicated with all said liquid chambers of said head chip,
a liquid in said liquid chambers being jetted through said nozzles by said energy generating elements, wherein
said head modules are each formed by a process including:
a first step for adhering said module frame to said one side of said nozzle sheet,
a second step for providing said nozzle sheet located in the region of said head chip arranging hole with a nozzle array so that each said nozzle is disposed at a position opposed to each said energy generating element of said head chip when said head chip is disposed in the region of said head chip arranging hole,
a third step for arranging said head chip, provided with said liquid chamber forming member, in said head chip arranging hole so that each said energy generating element of said head chip and each said nozzle formed in said nozzle sheet located in the region of said head chip arranging hole are opposed to each other, and
a fourth step for disposing said buffer tank, the inside surface of which is so shaped as not to be fitted into said head chip arranging hole with said head chip arranged therein and the outside surface of which is so shaped as to extend along the outside shape of said module frame, at a surface, on the opposite side of the surface of adhesion to said nozzle sheet, of said module frame, and
said method further includes a fifth step for arranging said head modules formed by said fourth step in said head module arranging holes of said head frame and adhering flange portions of said module frames, projected partly or entirely from the outside surfaces of said buffer tanks, to said head frame.

23-28. (canceled)

29. A method of manufacturing a head module which includes:
a head chip including a plurality of energy generating elements arranged at a fixed interval in one direction,
a nozzle sheet provided with nozzles for jetting liquid droplets,
a liquid chamber forming member laminated between the surface where said energy generating elements are formed of said head chip and said nozzle sheet so as to form a liquid chamber between each said energy generating element and each said nozzle, and
a module frame adhered to one side of said nozzle sheet to thereby support said nozzle sheet and provided with a head chip arranging hole for arranging said head chip therein,
a liquid in said liquid chambers being jetted through said nozzles by said energy generating elements, said method including:
a first step for adhering said module frame to said one side of said nozzle sheet,
a second step for providing said nozzle sheet located in the region of said head chip arranging hole with a nozzle array so that each said nozzle is disposed at a position opposed to each said energy generating element of said head chip when said head chip is disposed in the region of said head chip arranging hole,
a third step for arranging said head chip, provided with said liquid chamber forming member, in said head chip arranging hole so that each said energy generating element of said head chip and each said nozzle formed in said nozzle sheet located in the region of said head chip arranging hole are opposed to each other, and
a fourth step for arranging a support member for fixing said head chip from a surface, on the opposite side of the surface of adhesion to said nozzle sheet, of said module frame, at a surface on the opposite side of the surface where each said energy generating element is formed of said head chip.

30. The method of manufacturing a head module according to claim 29, wherein
said support member includes a fixing portion provided with a gap for forming an adhesive layer for fixing said head chip, and
said fourth step is so conducted as to bring said fixing portion into contact with said head chip and to fix said support member and said head chip by said adhesive layer.

31. The method of manufacturing a head module according to claim 29, wherein
said fourth step is so conducted as to mount said nozzle sheet on a base jig in close contact and, while maintaining this condition, fix said support member and said head chip.

32. A method of manufacturing a liquid jetting head which includes:
a plurality of head modules, and
a head frame provided with head module arranging holes for arranging therein said plurality of head modules disposed in series, said head frame adhered to each of said head modules arranged in said head module arranging holes,
each of said head modules including:
a head chip including a plurality of energy generating elements arrayed at a fixed interval in one direction,
a nozzle sheet provided with nozzles for jetting liquid droplets,
a liquid chamber forming member laminated between the surface where said energy generating elements are formed of said head chip and said nozzle sheet so as to form a liquid chamber between each said energy generating element and each said nozzle, and
a module frame adhered onto one side of said nozzle sheet to thereby support said nozzle sheet and provided with a head chip arranging hole for arranging said head chip therein,
a liquid in said liquid chambers being jetted through said nozzles by said energy generating elements, wherein
said head modules are each formed by a process including:
a first step for adhering said module frame to said one side of said nozzle sheet,
a second step for providing said nozzle sheet located in the region of said head chip arranging hole with a nozzle array so that each said nozzle is disposed at a position opposed to each said energy generating element of said head chip when said head chip is disposed in the region of said head chip arranging hole,
a third step for arranging said head chip, provided with said liquid chamber forming member, in said head chip arranging hole so that each said energy generating element of said head chip and each said nozzle formed in said nozzle sheet located in the region of said head chip arranging hole are opposed to each other, and
a fourth step for arranging a support member for fixing said head chip from a surface, on the opposite side of the surface of adhesion to said nozzle sheet, of said module frame, at a surface on the opposite side of the surface where each said energy generating element is formed of said head chip, and
said method further includes a fifth step for arranging said support members of said plurality of head modules formed by said fourth step in said head module arranging holes of said head frame and adhering each said module frame to said head frame.

33. The method of manufacturing a liquid jetting head according to claim 32, wherein
said nozzle sheet has a coefficient of linear expansion greater than those of said module frame and said head chip, and
said adhesion in said first step is conducted at the highest temperature in the manufacturing process of said liquid jetting head.

34-38. (canceled)
